(19) United States
(12) Patent Application Publication
(10) Pub. No.: US 2018/0322398 A1
(43) Pub. Date: Nov. 8, 2018

(54) METHOD, SYSTEM, AND ALGORITHM TO ANALYZE DATA SERIES TO CREATE A SET OF RULES

(71) Applicant: Kenneth Mbale, Bowie, MD (US)

(72) Inventor: Kenneth Mbale, Bowie, MD (US)

(21) Appl. No.: 15/969,362

(22) Filed: May 2, 2018

Related U.S. Application Data
(60) Provisional application No. 62/500,770, filed on May 3, 2017.

(51) Int. Cl. G06N 5/02; G06K 9/62; G06N 3/04

(52) U.S. Cl. CPC G06N 5/025; G06K 9/6227; G06N 3/04; G06K 9/6262

(57) ABSTRACT

Disclosed is a method of analysing a data series. The method includes receiving, using a communication device, a data series and analyzing, using a processing device, the data series. Further, the method includes dynamically generating, using a processing device, one or more rules based on the analyzing, wherein the one or more rules form a grammar, wherein the grammar is represented as a directed graph. Moreover, the method includes assigning one or more cycle values for one or more cycles in the directed graph to obtain an enhanced directed graph. A cycle in the one or more cycles is a path that leads back to a root node, wherein one or more charge values are assigned to the one or more cycles. Further, the method includes storing, using a storage device, the one or more rules, the one or more cycle values and the one or more charge values.

The current application claims a priority to the U.S. Provisional Patent application Ser. No. 62/500,770 filed on May 3, 2017.

### FIELD OF THE INVENTION

The present disclosure relates to data processing. More specifically, the present disclosure relates to a method, system, and algorithm to analyze a data series to create a set of rules.

### BACKGROUND OF THE INVENTION

Artificial Intelligence (AI) research may be defined as the search for a computational construct that may learn behaviors in an observable environment and may apply the observed behaviors in a manner that may ensure the success of the AI in predicting, or mimicking the observed behaviors. AI research may include a procedural approach based on defining and applying a set of rules or a connectionist approach based on the structure of the animal brain. Accordingly, procedural approach has produced useful technologies such as rules engines (SOAR (Laird, 2012) or RETE (Schor, Daly, Lee, & Tibbitts, 1986) (Bergmann, Ökrös, Ráth, Varró, & Varró, 2008), for example), and the connectionist approach has produced technologies such as the artificial neural network.

Artificial neural networks may be used for behavior detection and learning. Artificial neural networks may be composed of artificial neurons. The artificial neural network is an interconnection of artificial neurons in multiple layers of neurons. The internal layers between the input and the output may be hidden in, and the state of the layers may be unknown. The weight parameters may start as random values. During the training phase of the neural network, the weights may adjust using an adjustment function until the output of the neural network is correct. FIG. 2 is an illustration of a simple neural network 200 in accordance with prior art. An artificial neural network is an interconnected group of nodes. Here, each circular node represents an artificial neuron and an arrow represents a connection from the output of one artificial neuron to the input of another. The neural network 200 three main parts: the input layer (nodes 202-206), the hidden layer (nodes 208-216), and the output layer (node 218).

FIG. 3 is an illustration of a recurrent neural network 300 that may accept outputs as inputs allowing for the processing of data series, in accordance with prior art. Such a design may enable a hidden layer 302 to respond to an input 304 and preceding output 306. Accordingly, previous outputs may affect future outputs. For example, a neural network may be arranged that may accept any number of recurrent inputs using delay nodes.

Neural networks are widely used to solve many problems for which the procedural approach may not work well such as handwriting recognition, speech recognition, pattern detection, anomaly detection and prediction. However, neural networks are brittle and are not easily expanded. For example, consider if a neural network is needed to predict the next element in a symbolic time series [a, b, c, a, b, c, . . . ], a single input neural network may be created and trained until a predicts b, b predicts c and c predicts a. However, if the pattern changes to [a, b, c, a, b, c, d, a, b, c, a, b, c, d, . . . ], a single input may no longer suffice, and for the neural network to correctly predict [d], the neural network may need previous six inputs. Further, if there is an additional change in the pattern, further inputs may need to be known.

Neural networks may also apply to behavior. The artificial neural networks are opaque because of the hidden layers. The internal state may capture the knowledge that the neural network may have acquired during a training phase. Opacity is in direct opposition to the procedural approach where the rules and their sequence of execution leading to the output are well known and traceable. However, opacity is a cornerstone of the biologically inspired approach to AI.

In the biologically inspired approach, simple non-intelligent components are assembled and interconnected. Intelligence may thus emerge from the interaction of the non-intelligent components through the behaviors exhibited by the non-intelligent components. It is neither necessary to specify behaviors explicitly ahead of time nor to know the rules of the environment. However, there may be an inherent risk. For instance, a self-driving car may need to consider previous decisions and current circumstances to make a next decision. A recurrent neural network may support such a requirement. However, the number of inputs may be fixed. While all the inputs for the self-driving car may be determined, such inputs may not be clear for animals. Examining animal behaviors, there may also be a limit to a number of inputs that may be processed. An animal or a human being cannot recall an entire history of experiences to choose a next behavior. Nonetheless, within that limit, patterns of actions and states may be found, and suitable behaviors may be learned.

Conditioning may be a pattern of stimulus and response, or, behavior and consequence, which a learner may internalize after several exposures. Further, behaviorism proposes that all learning occurs through conditioning, where an environment or a trainer may be a source of stimuli and the responses. Behaviorism suggests the notion of correlated patterns as a basis for learning. Behavior in a learner may be independent of internal mental states. Behaviorism includes two main concepts; classical conditioning and operant conditioning. In classical conditioning, a naturally occurring stimulus may be associated with a response, and a neutral stimulus may be associated with a previous naturally occurring stimulus. The effect in a learner may be to associate the neutral stimulus with the natural response, even in the absence of the naturally occurring stimulus. The neutral stimulus is referred to as the conditioned stimulus and the response as the conditioned response. In operant conditioning, an association may be created within a learner between a behavior and a consequence for that behavior, i.e., a reward or a punishment.

However, behaviorism may not be a basis for learning or cognition (Chomsky, 1967) Mechanisms for processing systems of knowledge, including language, may be inherent, and may interact in complex ways characterized generally as intelligence. For example, humans are not born knowing how to speak any particular language but are born with the ability to acquire and process a natural language.

An innate mechanism within a learner may process perceived patterns with a specific intent to learn language. The learning mechanism may support several strategies, such as conditioning (reinforcement learning), imitation, extrapolation, and experimentation. No single strategy is ideal for every learning situation. Observational learning allows learning to take place using a model instead of relying on conditioning. Any model a learner may observe may be suitable for teaching a response through observation. A model may be another individual who may be exhibiting the behavior under observation. Since there is no reinforcement in observational learning, the learner may need to filter noise in perceptions to focus attention on the relevant information.

Further, observational learning may also include imitation and acquiring a behavior from observation. However, observational learning may also include a notion that the learner may learn not to acquire the behavior (Steifel, 2012).

Further, the ability to filter irrelevant sensory information and to focus on relevant information is necessary for higher-order cognitive functions such as selective attention and working memory. This ability may be based on spontaneous alpha oscillations. (Foxe & Snyder, 2011).

Yet further, three broad classes of behavior; instinctive, acquired and deliberate, are generally recognized. Instinctive behavior may require the least cognitive deliberation, and may not need to be learned (Chouhan, Wolf, Helfrich-Förster, & Heisenberg, 2015; Heisenberg, 2014). Deliberate behavior may require the highest degree of cognitive deliberation during performance. Such behaviors may be complex and therefore performance of such behaviors may be to be slow, in comparison to instinctive behaviors, because of substantial participation of cognitive deliberation. Acquired behavior is may be called as deliberate behavior that, through repetition, may require substantially less cognitive deliberation than deliberate behavior, and is faster than a deliberate behavior because of lesser reliance on active deliberation.

FIG. 4 is an illustration of a network 400 for selecting instinctive behaviors in accordance with prior art. Initially, there may be only instinctive behaviors to choose from. When a stimulus 402 occurs, the agent may trigger an appropriate behavior 406 to respond, which may be the output of a Response Selection function 404. For example, a baby's response to most negative stimuli is to cry. Over time, deliberate behaviors appear. For example, the baby may learn to hear and pronounce words from a maternal language and a same stimulus that may have caused the baby to cry earlier may cause the utterance of words, along with crying. Eventually, deliberate behaviors may become acquired behaviors. Accordingly, the response selection function is flexible enough to change its output from an instinctive response to an acquired response or a deliberate response for the same stimulus. As depicted in FIG. 5, in accordance with prior art, for the response selection function 504 to change choice of response 506 for some stimulus 502, some information about outcomes 508 of the available behaviors is required. In living beings, stimuli may be embedded in a time-series of physical and mental perceptions that may include actions performed and data points about the environment and an internal state of the living being. The information about outcomes may be a projection of the utility of the behavior in the given situation. Therefore, the process of creating behaviors may be analyzed as the result of the analysis of a time-series of perceptions. Accordingly, in accordance with prior art, the analysis may result in an identification of deliberate behaviors that may mature into acquired behavior once utility of the deliberate behaviors may be demonstrated, as shown in FIG. 6. In this model, an instinctive behavior may be atomic. An acquired behavior may be composed from instinctive and acquired behaviors. A deliberate behavior may be composed from instinctive, acquired and deliberate behaviors.

Further, behavior composition function 702 may administer the body of behaviors as depicted in FIG. 7, in accordance with prior art. Behavior composition may create, modify and delete acquired and deliberate behaviors, with processing of time-series of perceptions 704. With a rapid growth in number of behaviors, behaviors with low utility, as determined from information of outcomes 706 may be expunged. Instinctive behaviors may be static and the number of acquired behaviors may steady over time as an adaptation to the environment may occur.

Behavior selection may require the ability to identify host behavior in a time-series of perceptions, and then to predict an outcome once applied. Intelligence may be described as an ability to observe an environment, detect patterns in the observations, learn new behaviors, and select a right behavior to apply in a circumstance. Therefore, for intelligent behavior selection and behavior acquisition, there is a need for system, method, algorithm and mechanism that can detect patterns in a time-series of perceptions and store patterns efficiently.

Therefore, there is a need for improved methods, systems, and an algorithm to analyze a data series to create a set of rules that may overcome one or more of the abovementioned problems and/or limitations.

### SUMMARY

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

In some embodiments, a method of analyzing a data series. The method includes receiving, using a communication device, a data series. Further, the method includes analyzing, using a processing device, the data series. Yet further, the method includes dynamically generating, using a processing device, one or more rules based on the analyzing. The one or more rules form a grammar. The grammar is represented as a directed graph comprising one or more nodes and one or more edges, wherein the one or more nodes representing the one or more rules, wherein the one or more edges forming a unique path through the one or more nodes. Moreover, the method includes assigning one or more cycle values for one or more cycles in the directed graph to obtain an enhanced directed graph, wherein a cycle in the one or more cycles is a path that leads back to a root node, wherein one or more charge values are assigned to the one or more cycles. Further, the method includes storing, using a storage device, the one or more rules, the one or more cycle values and the one or more charge values.

According to some aspects, a system of analyzing a data series is disclosed. The system includes a communication device configured to receive a data series. Further, the system includes a processing device configured to analyze the data series. The processing device is further configured to dynamically generate one or more rules based on the analyzing, wherein the one or more rules form a grammar, wherein the grammar is represented as a directed graph comprising one or more nodes and one or more edges, wherein the one or more nodes representing the one or more rules, wherein the one or more edges forming a unique path through the one or more nodes. Further, the processing device is configured to assign one or more cycle values for one or more cycles in the directed graph to obtain an enhanced directed graph, wherein a cycle in the one or more cycles is a path that leads back to a root node, wherein one or more charge values are assigned to the one or more cycles. Moreover, the system includes a storage device configured to store the one or more rules, the one or more cycle values and the one or more charge values.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 is an illustration of a simple neural network in accordance with prior art.

FIG. 3 is an illustration of a recurrent neural network in accordance with prior art.

FIG. 4 is an illustration of a network for selecting instinctive behaviors in accordance with prior art.

FIG. 5 is an illustration of a network for changing instinctive behaviors to acquired behaviors in accordance with prior art.

FIG. 6 is an illustration of a model for changing instinctive behaviors to acquired behaviors in accordance with prior art.

FIG. 7 is an illustration of a network with a behavior composition function in accordance with prior art.

FIG. 8 is an illustration of a directed graph for a reflexive series in accordance with exemplary embodiments.

FIG. 9 is an illustration of a directed graph for a periodic series in accordance with exemplary embodiments.

FIG. 10 is an illustration of a directed graph related to a cyclical pattern of symbols in accordance with exemplary embodiments.

FIG. 11 is an illustration of a directed graph comprising seasons in accordance with exemplary embodiments.

FIG. 12 is an illustration of a hybrid directed graph in accordance with exemplary embodiments.

FIG. 13 is an illustration of a Kasi element modeled on a perceptron in accordance with some embodiments.

FIG. 14 is an illustration of a network comprising multiple connected Kasi in accordance with some embodiments.

FIG. 15 is an illustration of a Sarufi created by the Kasai algorithm in accordance with some embodiments.

FIG. 16 is an illustration of a merged Kasi in accordance with some embodiments.

FIG. 17 is an illustration of a simplified version of the Sarufi of FIG. 15.

FIG. 18 is an illustration of a Sarufi created by the Kasai algorithm in accordance with some embodiments.

FIG. 19 is an illustration of a Sarufi with cycles in accordance with some embodiments.

FIG. 20 is an illustration of a Sarufi with cycles in accordance with some embodiments.

FIG. 21 is an illustration of a simplified version of the Sarufi of FIG. 20.

FIG. 22 is an illustration of a singleton Kasai in accordance with some embodiments.

FIG. 23 is an illustration of a Kasai Network in accordance with some embodiments.

FIGS. 24 A-J are illustrations of directed graphs including different types of seasonality that may occur in a data series in accordance with exemplary embodiments.

FIG. 25 is an illustration of a hardware Kasi element in accordance with some embodiments.

FIG. 26 is an illustration of a Kasai chip in accordance with some embodiments.

FIG. 27 is a block diagram of the system for facilitating analysis of a data series to create a set of rules in accordance with some embodiments.

FIG. 28 is a flowchart of a method of facilitating analysis of a data series to create a set of rules in accordance with some embodiments.

FIG. 29 is a block diagram of a computing device for implementing the methods disclosed herein, in accordance with some embodiments.

### DETAIL DESCRIPTIONS OF THE INVENTION

As a preliminary matter, it is readily understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, is implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of facilitation of management of cryptocurrency based loyalty points associated with one or more of a product and a service, in accordance with some embodiments, embodiments of the present disclosure are not limited to use only in this context.

### Overview

Disclosed is an algorithm that may analyze a data series to create a set of rules that describe the observed data series. The algorithm may be called as Kasai and may emulate learning behavior from symbolic observations and a complexity analysis. The Kasai algorithm may analyze an input sequence to generate a set of rules that may describe the input sequence. The set of rules, called as Sarufi, may then be used to analyze, reproduce, or compare one or more sequences, or as a memory. The Kasai Algorithm may merge connectionist approach and procedural approach to Artificial Intelligence.

The inputs to the Kasai algorithm may be symbolic and may not be, for example, numbers with a mathematical relationship. In an instance, one or more observations that may help a predator, such as a lion, determine the location of one or more preys, such as gazelles a certain time of day may be considered. Observations such as the time of day, the temperature, the scent on the wind, the direction of the wind, and a history of experiences, may be used to make the decision about where to hunt.

As another example, if an individual is observed, actions performed by the individual may be represented symbolically. For example, a hand motion primitives dataset (Bruno, B., Mastrogiovanni, F., Sgorbissa, A., Vernazza, T., Zaccaria, 2013) may provide accelerometer data reflecting behaviors such as brush_teeth, climb_stairs, comb_hair, descend_stairs, pour_water, drink_glass, eat_meat_eat_soup, getup_bed, liedown_bed, sitDown_chair, and standUp_chair. Each behavior may be denoted using two letters for brevity. As such, observations of the behaviors may yield an exemplary time series that may be represented as [GB, BT, CH, DS, PW, DG, DC, ES, DG, UC, CS, LB]. Given several series of observations of similar time series, we patterns and anomalies may be detected. However, it may be noted that a mathematical formula to describe the time series, and relationships between individual tokens representing behaviors may not exist. A procedural approach may be required to describe rules such as DC (sitDown_chair) must be performed before UC (standup_chair).

Further, in an instance, two series of observations; P1=[k, b, a, z, q, p, m] and P2=[k, a, b, k, a, b] may be considered. P1 may be qualified as random as P1 may not contain any pattern. Accordingly, observational learning may not be possible in a random series. P2 may be as qualified as systematic because P2 may contain a pattern. As such, observational learning may be possible due to the presence of at least two discernible episodes [k, a, b]. P2 may be simple and obvious. In nature, observational learning may occur using much more complex intertwined series. The detection of a pattern in a series may be a function of a method used to detect the pattern. For example, as treating each token in P1 as unrelated tokens, P1 may not have a pattern. However, a pattern may exist if the detection method may be aware of the Latin alphabet. In such as case, the relationships between [k, b, a] may be the same the relationship between the tokens of [z, q, p]. The relationship may predict which token may follow [m] if P1 is systematic. The pattern in P2 is obvious and does not depend on a lexical relationship between the tokens. Accordingly, detection methods may not detect patterns that the detection methods may not be designed to detect. Henceforth, letters may be used to symbolize observations, without regard to the lexical order as if the alphabet may not exist.

The Kasai algorithm may detect patterns in systematic series of tokens. A token may be a raw datum that the detection method may process. Data that may not be tokenized may not be presented to the Kasai algorithm. For example, if the methods of detection of P1 or P2 are presented with a number instead of a letter, a meaningful token may not be created for a number. On the other hand, if a token can be created, the datum may not be ignored.

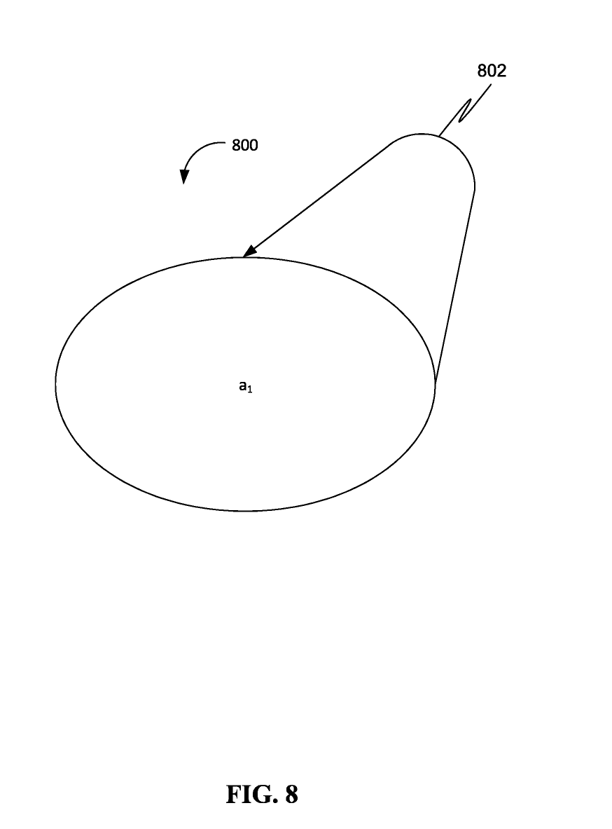

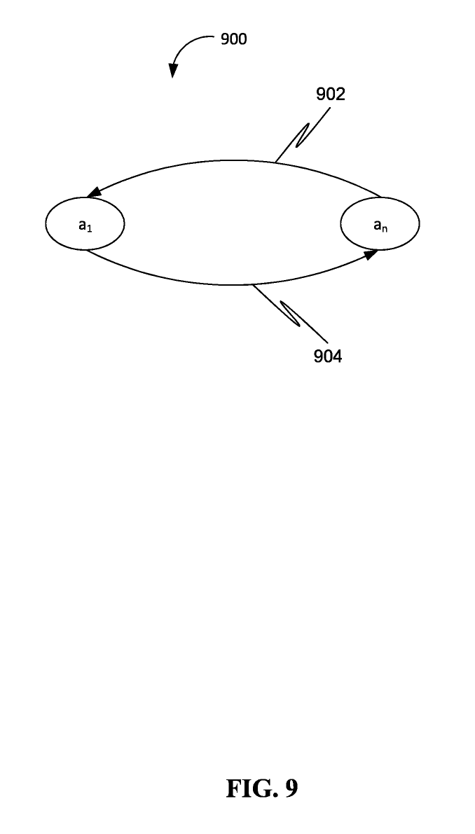

Further, in accordance with exemplary embodiments, two directed graphs 800 and 900 are shown in FIGS. 8-9. The directed graph 800 relates to a reflexive series. The directed graph 900 relates to a periodic series 900. The reflexive pattern of FIG. 8 may use the same token; P3=[a, a, a, a, . . . ]. The periodic pattern of FIG. 9 may repeat a series of tokens; P4=[a, b, c, a, b, c, . . . ]. In the FIGS. 8-9, the edges 802, 902 and 904 indicate that a sequence may repeat at some point. In the case of P3, the sequence repeats immediately. In the case of P4, the sequence repeats after the token c, when n=3.

Further, a systematic pattern may be composed of token series. A token series may be referred to as a symbol. The method of detection of the token series may produce the symbol. A symbol may represent a token series that may be a component of a systematic pattern. To distinguish symbols from tokens, a symbol may be labeled using a capital letter. A symbol may be a finite token series such as S=[a, b, c].

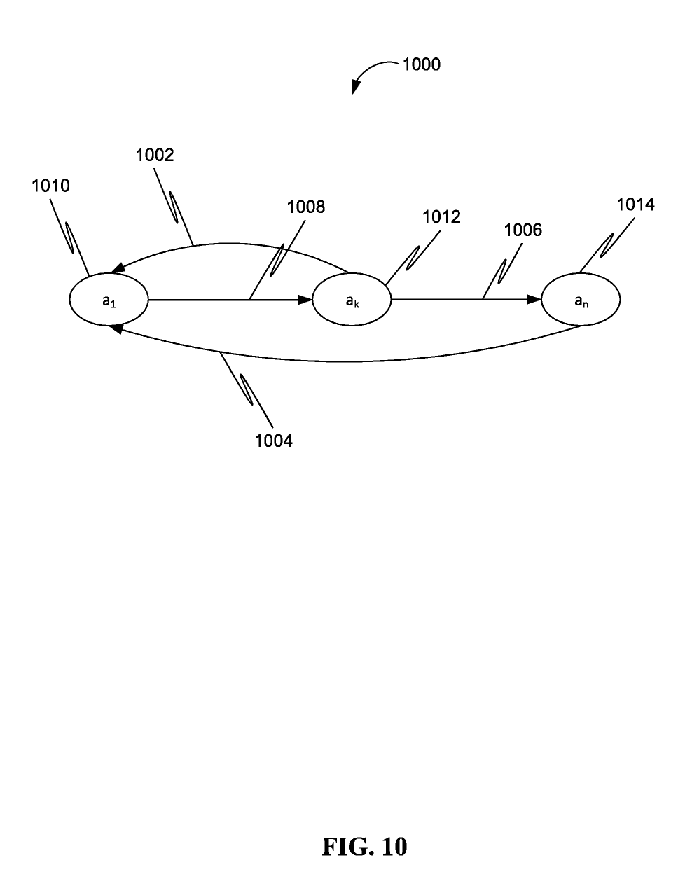

In accordance with exemplary embodiments, FIG. 10 illustrates a directed graph 1000 related to a cyclical pattern of symbols. The directed graph 1000 includes edges 1002-1008 between nodes 1010-1014. The cyclical pattern may occur when a symbol may periodically occur in the series. A series P5=[a, b, c, a, b, c, a, b, k, a, b, c, a, b, c, a, b, k, . . . ] may contain symbols S=[a, b, c] and R=[a, b, k]. A tokenized P5 may be shown as P5=[S, S, R, S, S, R, . . . ] reducing the series to a periodic pattern. Cyclical patterns are periodic patterns of symbols. A cyclical pattern may contain a cycle, with the repetition of one or more symbols. For example, in series P5, symbol S may cycle once before the occurrence of symbol R. At the token level, token b occurs two times before token k occurs.

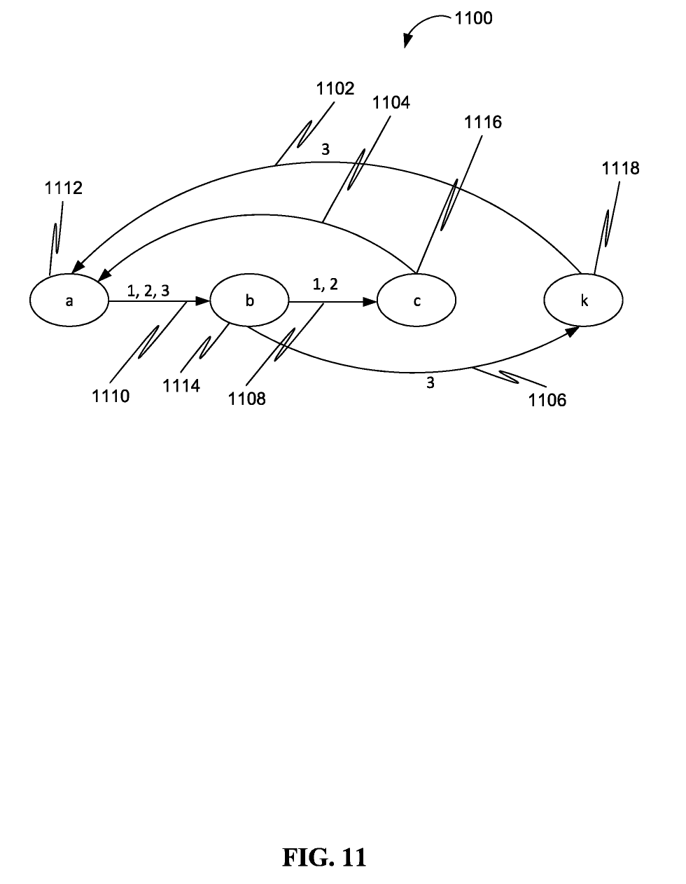

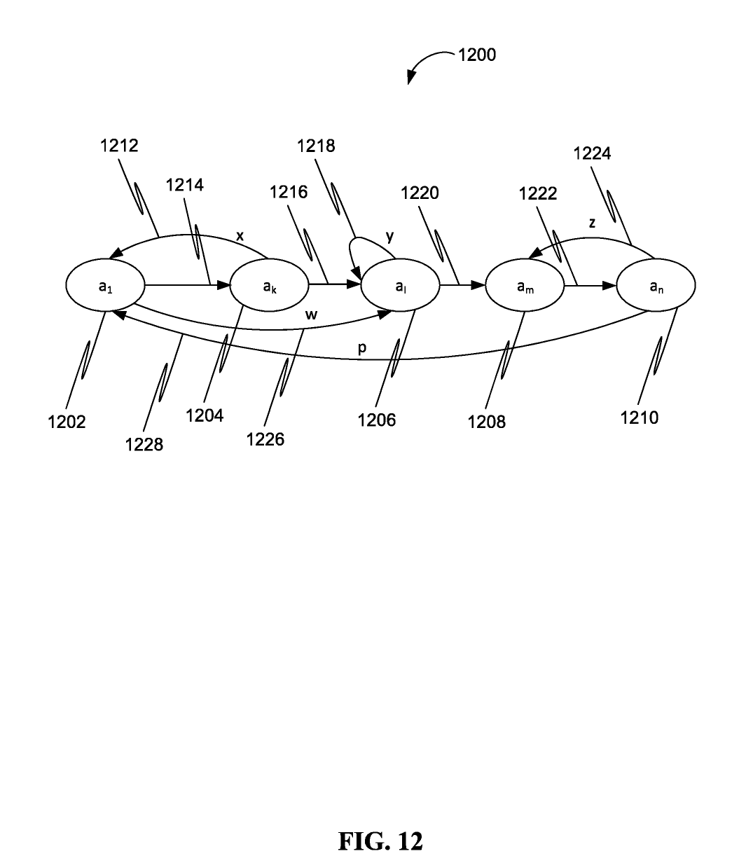

Further, in accordance with exemplary embodiments, FIG. 11 is an illustration of a directed graph 1100 that includes edges 1102-1110 between nodes 1112-1118. The directed graph 1100 produces [a, b, c] on cycles 1 and 2, and [a, b, k] on cycle 3, ad infinitum, like series P5. Each token that may repeat may be called as a simple season. When two or more tokens may repeat, a complex season may emerge. A simple season may have no sub-seasons whereas, a complex may season contains at least one sub-season. Within each season, there may be sub-seasons, sub-sub-seasons, and so on. The seasons may occur in a certain order over an epoch. An epoch may be defined as a period over which all tokens may appear at least once, before starting again. The length of an epoch may be the sum of the cycle traversals the pattern contains. Accordingly, a hybrid directed graph 1200, as shown in FIG. 12, may contain any combination of reflexive, periodic and cyclical patterns between edges 1202-1110 between nodes 1212-1228.

Further, Kasai algorithm may process a data series and derive one or more rules that may produce the data series. A set of rules that mirror a data series have several advantages. The set of rules may act as a memory by capturing static and dynamic characteristics of the data series. The set of rules enables the prediction of future state of the data series based on the current state and supports comparison of data series using set operations and graph analysis techniques, which may be more efficient and insightful than brute force comparisons.

The Kasai algorithm may dynamically build a set of rules that may describe a sequence processed. A rule takes the form symbol→token. The rule Sₓ→tₙ denotes that symbol Sₓ predicts token tₙ. The collection of rules the Kasai may build may be called a Grammar. Within the Kasai algorithm, the grammar may be represented as a directed graph. The nodes of the graph may be tokens, and one or more edges may be directed and may form a unique path through the nodes. Thus, a Path may be a sequence of edges may connect a set of nodes such that the node that an edge may end in becomes the node at which the next edge starts. The graph may be fully connected and all nodes may be reachable. Each rule of the form Sₓ→tₙ causes a set of nodes that form the symbol S and tₙ to form a path. The first node that may be added to the graph may be referred to as the Root. However, any node may be designated as the root as all nodes are interconnected. By convention, the first node is generally denoted as the root. However, the best root may be the most frequently occurring node in the sequence. Unfortunately, the most frequently occurring node may not be known at the outset, or, may change over time. The Kasai algorithm may refactor the grammar to reposition the root node.

The grammar of a sequence may be a static construct but the description of the sequence may need to include the dynamic aspects of the sequence a well. The grammar may describe the static structure of the sequence using rules and paths. To capture the dynamic aspects, the Kasai algorithm may introduce a concept of cycles overlaid on top of the grammar. A Cycle may be a path that may lead back to the root node. The directed graph that may capture both static and dynamic aspects of the sequence may be called a Sarufi. As such, FIG. 12 also shows an exemplary Sarufi 1200. A pattern may be seasonal whenever a Sarufi has cycles greater than one (1).

Each cycle in a Sarufi may have a charge. The charge may build by one each time the root node may be crossed. When the charge reaches the cycle value, the cycle may be active. Once the cycle may have been traversed, the charge of the cycle may revert to zero (0). An ideal Sarufi may be defined as when the root node may be in cycle 1 and a path from each node to every other node may exist. For example, a Sarufi of a genome will be ideal. However, the Sarufi describing weather will not be ideal because the Sarufi may start somewhere in the middle of the weather pattern. Eventually, the non-ideal Sarufi will become ideal because the Kasai algorithm may refactor the Sarufi as new patterns are discovered in the data. Systematic patterns result in ideal Sarufi. The Kasai Algorithm may only produce rules reflecting the data series processed by the Kasai algorithm to date and the rules produced may fully reproduce the data series.

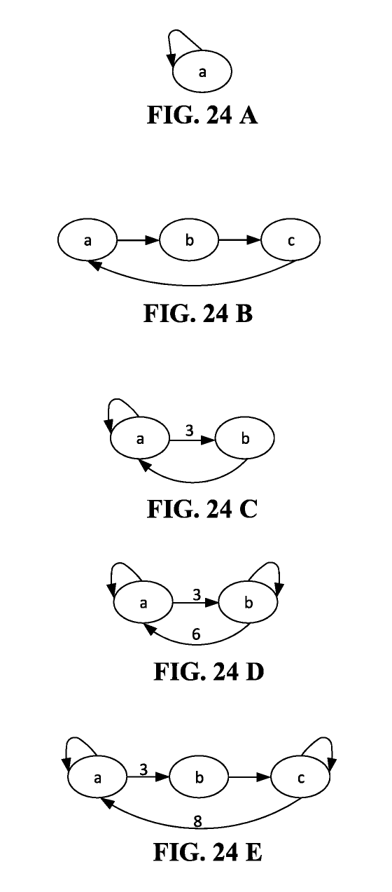

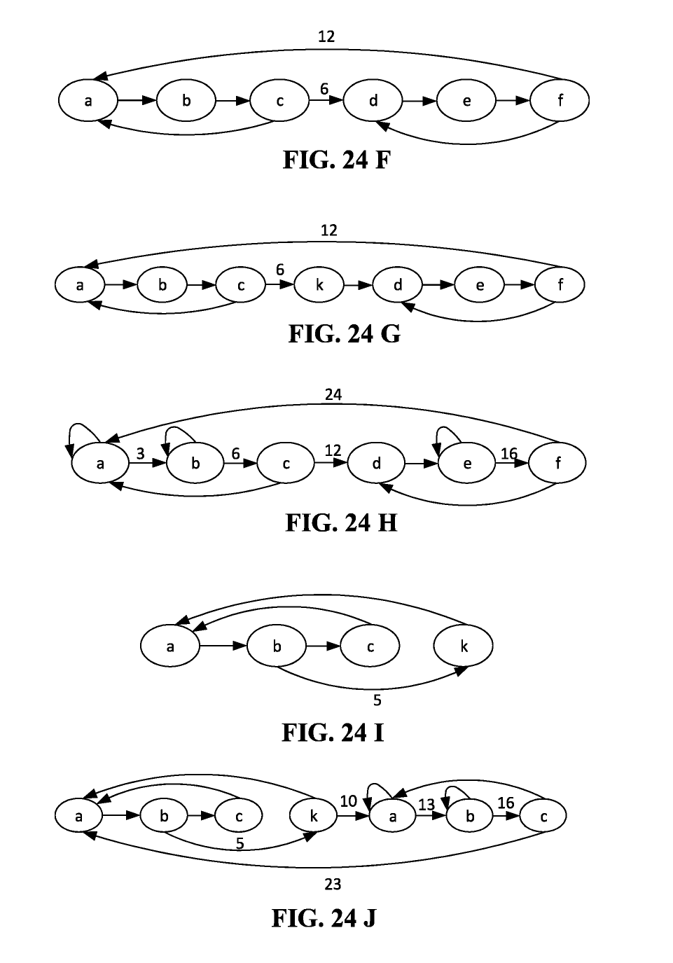

FIG. 24 A-E illustrate directed graphs including different types of seasonality that may occur in a data series and represented by one of the patterns (reflexive, periodic, cyclical or hybrid) in the Kasai algorithm. Each of the directed graphs may include one or more nodes and one or more edges.

FIG. 24 A illustrates a directed graph related to an infinite series of the same season where each epoch has only one season. Kasai algorithm may represent this type of series as a reflexive pattern.

FIG. 24 B illustrates a directed graph showing an epoch with same-length multiple seasons. An infinite series of multiple seasons of the same length is illustrated. Each epoch may have 3 seasons [a], [b] and [c], and corresponds to a periodic pattern in the Kasai algorithm.

FIG. 24 C illustrates a directed graph showing an epoch with varying length seasons. An infinite series of multiple seasons of different lengths is illustrated and may be obtained by combining a finite number of epochs with a simple season. As illustrated, each epoch may have 3 [a] seasons followed by a [b] season and may correspond to a reflexive and periodic pattern in the Kasai algorithm.

FIG. 24 D illustrates a directed graph showing an epoch with repeating seasons of varying length. An infinite series of multiple seasons of different lengths is illustrated. A finite number of one or more epochs may be combined to obtain an epoch with repeating seasons of varying length. As illustrated, each epoch has three [a] seasons followed by three [b] seasons and corresponds to a reflexive and periodic pattern in the Kasai algorithm.

FIG. 24 E illustrates a directed graph showing multiple epochs with varying length seasons. An infinite series of multiple seasons of different lengths is illustrated. Multiple finite epochs with a simple season may be combined to obtain multiple epochs with varying length seasons and may correspond to a reflexive, periodic and cyclical pattern in the Kasai algorithm.

FIG. 24 F illustrates a directed graph showing multiple epochs with multiple complex seasons. An infinite series of complex seasons may be obtained by combining multiple finite numbers of case 2 epochs. Each epoch may contain multiple complex seasons and may correspond to a periodic and cyclical pattern in Kasai.

FIG. 24 G illustrates a directed graph showing multiple epochs with multiple complex seasons. An infinite series of complex seasons may be obtained by combining multiple finite numbers of epochs with simple seasons. Each epoch may contain multiple complex seasons, and simple seasons and may correspond to a periodic and cyclical pattern in the Kasai algorithm.

FIG. 24 H illustrates a directed graph showing multiple epochs with multiple complex seasons. An infinite series of complex seasons may be obtained by combining multiple finite numbers epochs with simple seasons, with repeating seasons and may correspond to a reflexive, periodic and cyclical pattern in the Kasai algorithm.

FIG. 24 I illustrates a directed graph showing multiple epochs with multiple complex seasons. An infinite series of overlapping complex seasons is illustrated. The exemplary complex seasons [a b c] and [a b k] have 2 seasons that overlap (a and b) and corresponds to a periodic and cyclical pattern in Kasai.

FIG. 24 J illustrates a directed graph showing multiple epochs with multiple complex seasons. An infinite series of overlapping and/or non-overlapping complex seasons is illustrated and may be obtained by combining multiple finite numbers of one or more types of epochs with simple seasons, or complex seasons. The infinite series of overlapping and/or non-overlapping complex seasons corresponds to a reflexive, periodic and cyclical pattern in Kasai.

Accordingly, no sequence may be formed at a level higher than complex seasons and seasonality in a data series may only contain reflexive, periodic, cyclical and hybrid patterns. Since the Kasai algorithm creates rules for any reflexive, periodic, cyclical or hybrid patterns, the Kasai algorithm also creates a complete set of rules for seasonal patterns.

Further, the Kasai algorithm may be implemented with a neural network. A more abstract may need to be built on top of a neural network. The new object may be called as a Kasai. The Kasai may inherit the behavior of the neural network abstract data type. Further, the Kasai may be implemented on a graph database, a hash table, a list structure, etc. The core atomic element of the Kasai may be called a Kasi (the Kasai Abstract Data Type).

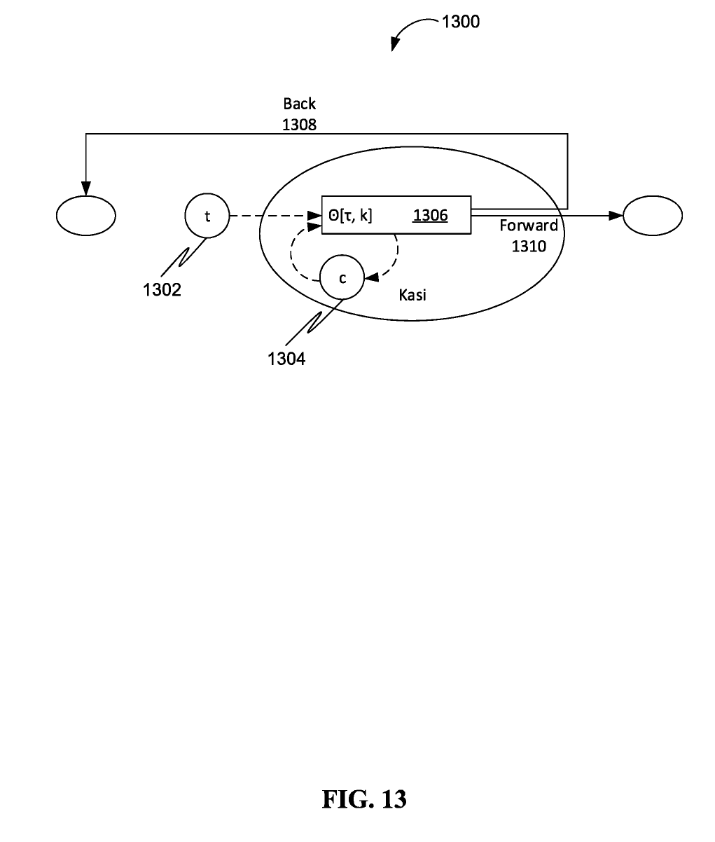

Referring now to FIG. 13 showing a Kasi element modeled on a perceptron, in accordance with some embodiments. The Kasi element may accept one external input token 1302 denoted t and, an internal recurrent input called charge 1304 and denoted c. The activation function 1306 may be denoted Θ (Theta). The arguments in brackets may be set when the Kasi is instantiated. The argument τ (Tau) may be the expected matching token and the argument κ (Kappa) is the target cycle count. For instance, in FIG. 12, the rightmost Kasi may be initialized with κ=3 and τ=[k]. The Θ function may be as follows:

```
function Θ (t, c):
    If t = τ and c = κ
      c = 0;
      return Forward;
    else if t = τ
      return Back;
    else
      return NULL;
  end if;
end function Θ;
```

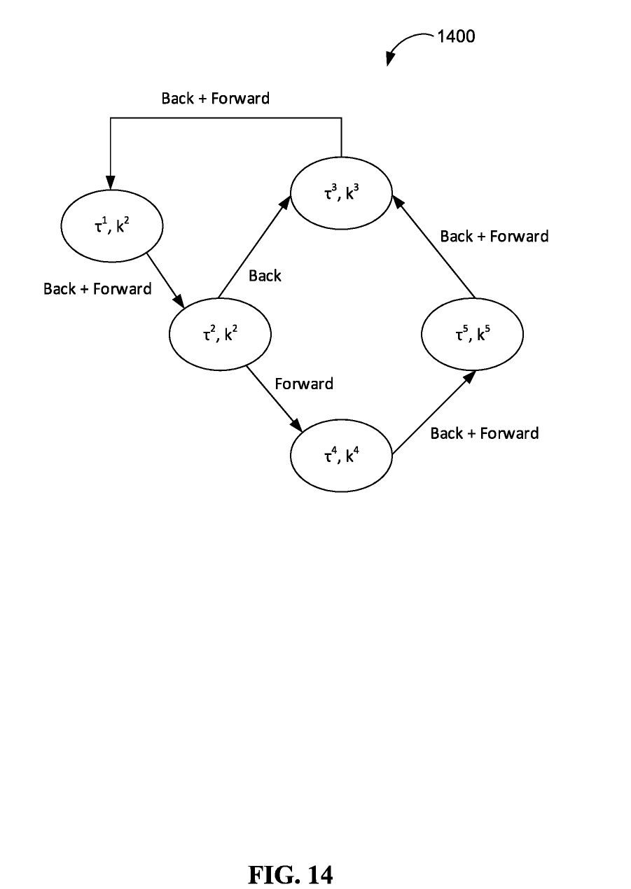

The charge variable (c) 1304 may be special and there may be only one instance of c 1304 associated with each Kasi. Each time an input t 1302 is processed by the Kasai object, all c 1304 variables may be incremented by 1. The connections Back 1308 and Forward 1310 may point to next Kasi that may accept the next input t 1304. If the inputs t 1302 and c 1304 match τ and κ, the Kasi mat return the Forward link 1310. If the input t 1302 matches τ but c 1304 does not match κ, the Kasi may return the Back link 1308. If the input t 1302 does not match τ and the Kasi may return a NULL link. As shown in FIG. 11, each node on the directed graph may correspond to a Kasi. A Sarufi as shown in FIG. 14 may be a network that may connect multiple Kasi. A Sarufi may be the data arrangement in memory, a graph of the interconnected Kasi. The Kasai and the Kasi may be instantiated objects. One Kasai object contains all Kasi objects and the Sarufi. The mainline of the Kasai object is as follows:

```
Kasai Mainline:
  loop: t = next data series input;
  if activeKasi is the rootKasi
  for all kasi: //parallel for
    kasi->c = kasi->c + 1;
  predecessorKasi = activeKasi;
  activeKasi = activeKasi->K(t);
  if activeKasi is NULL
    signalAnomaly(t,predecessorKasi-> T )
    if learning mode is active
      activeKasi = adjustSarufi( );
    end if
  else
    signalPrediction (activeKasi-> T ) //prediction
  end if;
  end loop;
end Kasai Mainline;
```

The Kasai may begin by incrementing the c 1304 of all Kasi upon receiving the input t. The Kasai may use the last link received to apply its Θ function 1306 using t 1302 (and c 1304). If the Kasai receives a link to another Kasi (Back 1308 or Forward 1310), the Kasai signals τ. In effect, the Kasai is predicting the next value of the data series. Signaling means that the Kasai may inform the overall client application that the Kasai is using the Kasai. Signaling could be implemented as a message or a printout or file output, for example.

When the Kasi returns a NULL, an anomaly may have occurred. The anomaly may be the fact that the expression (t=τ) is false. If the Kasai is in learning mode, the Kasai may modify the Sarufi to deal with the anomaly. If the Kasai is not in learning mode, the Sarufi is not modified. In either case, the Kasai may signal the state information about the anomaly (i.e., the input token t 1302 and the last correct token τ).

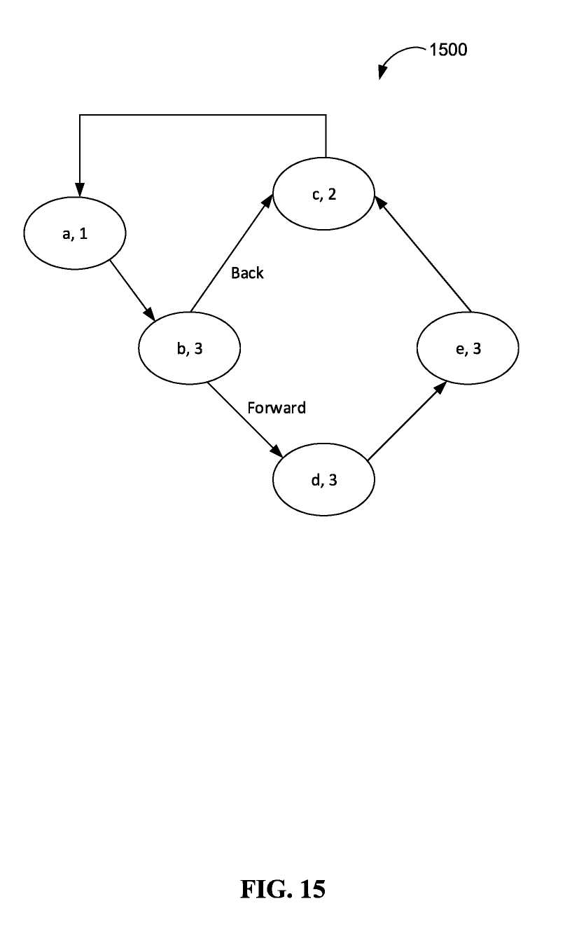

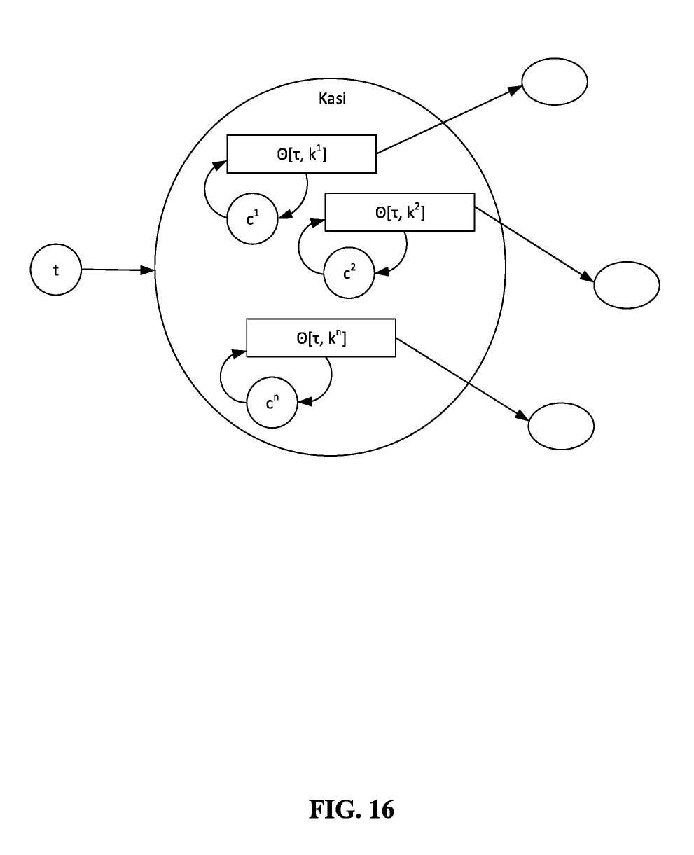

FIG. 14 depicts a Sarufi 1400 created by the Kasai algorithm, in accordance with some embodiments. The Sarufi 1400 may include one or more nodes connected by one or more edges. As an example, τ=[a, b, c, d, e] may be applied to FIG. 14 from left to right, where the Back link points to [t=b]. Let the charges be κ=[1, {2,3}, 3, 3, 3] where the κ for Back is 2 and for Forward is 3. FIG. 15 is an illustration of the resulting Sarufi 1500. Then, the Sarufi 1500 may encode the sequence: P=[a, b, c, a, b, c, a, b, d, e, c, a, b, c, a, b, c, . . . ]. The infinitely long series may be fully represented using a very compact representation. The series may be recurrent and, unlike a neural network, the recurrence of the series may be infinitely expanded to allow for comparison of structures of patterns in series. The adjustSarufi ( ) function may modify the Sarufi when an anomaly is detected. The anomaly may not have occurred at the current Kasi, but at a predecessor Kasi that may have directed the Kasai algorithm incorrectly. The correction may be performed by creating a new Kasi using a current highest c value as κ and unexpected input token t as τ. The new Kasi may need to connect to the predecessor Kasi. The predecessor Kasi may not be modified as the parameter κ cannot be altered after the creation of the Kasi. However, a new Kasi may need to be created in the same position in the Sarufi as the predecessor Kasi. The new predecessor may use the same τ as the other predecessor but may use the new κ. Therefore, a possibility that the Θ function could return more than one Kasi link may exist. To eliminate this problem, the predecessor Kasi may be merged, as shown in FIG. 16 and the Θ function may be modified accordingly into a more general form since Back and Forward links have been replaced with unlimited links.

A Kasi to may now branch to more than two other Kasi thus becoming general. The new Θ function may become parallel so that all Θ are evaluated simultaneously inside the Kasi:

```
function Θ (t, c):
  If t is equal to τ
    for all K: //parallel
      if cⁿ >= κⁿ
      cⁿ = 0;
      map (κⁿ, Link);
    end if;
  link = reduce by maximum κⁿ
  return link;
  else
    return NULL
  end if;
end function Θ;
```

The general Θ function may use map reduce. For each Θⁿ where cⁿ>=κⁿ, the link and the κⁿ are mapped, and the charge c is reset. The Kasi may perform such actions in parallel, for all instructions. The reduce step may select the link with the largest κⁿ in the map and return the link. The reduce step function may always return a link if input t=τ, because the adjustSarufi( ) function always creates at least one Kasi with a function definition Θ [τ, 1]. Given the general Kasi function ϕ definition, the specification of the adjustSarufi( ) function may be illustrated as follows:

```
function adjustSarufi ( ):
  newKasi = new Kasi (t, global_c)
  If predecessorKasi is NULL //This is a new Sarufi
    rootKasi = newKasi;
  else
    predecessorKasi->new Θ (global_c, newKasi);
  end if;
  return newKasi;
end function adjustSarufi:
```

When the input t is the unexpected input that cause an anomaly, the input may need to be added to the Sarufi. It occurred at the current maximum charge within the Kasai that it stores in the global_c variable. We now finalize the Kasai mainline:

```
Kasai Mainline:
  predecessorKasi = NULL;
  rootKasi = NULL;
  global_c = 0;
  loop:
    t = next data series input;
    if rootKasi is NULL //create the firstSarufi
      activeKasi = adjustSarufi( );
    if activeKasi is the rootKasi
      global_c = global_c + 1;
      for all kasi: //parallel for
        kasi->c = kasi->c + 1;
    end if;
    if t is equal to activeKasi-> τ //no anomaly
      predecessorKasi = activeKasi;
      activeKasi = activeKasi-> Kasi( );
      signalPrediction (activeKasi-> τ) //prediction;
    else //anomaly
      signalAnomaly(t,predecessorKasi-> τ)
      if learning mode is active
        activeKasi = adjustSarufi(t, predecessorKasi);
      else
        activeKasi = rootKasi;
      end if;
    end if;
  end loop;
end Kasai Mainline;
```

The Kasi function is finalized given that the Kasai mainline detects the anomaly and no longer invokes the Kasi when an anomaly occurs:

```
function Kasi ( ): //Variables c, κ, τ are part of Kasi object. If t is not τ,
this function is not called.
    for all Θ: //parallel
      if cⁿ >= κⁿ
      cⁿ = 0;
      map (κⁿ, Link);
    end if;
  link = parallel reduce by maximum κⁿ
  return link;
end function Kasi:
```

The Θ function is designed to take advantage of multiple threads or processors.

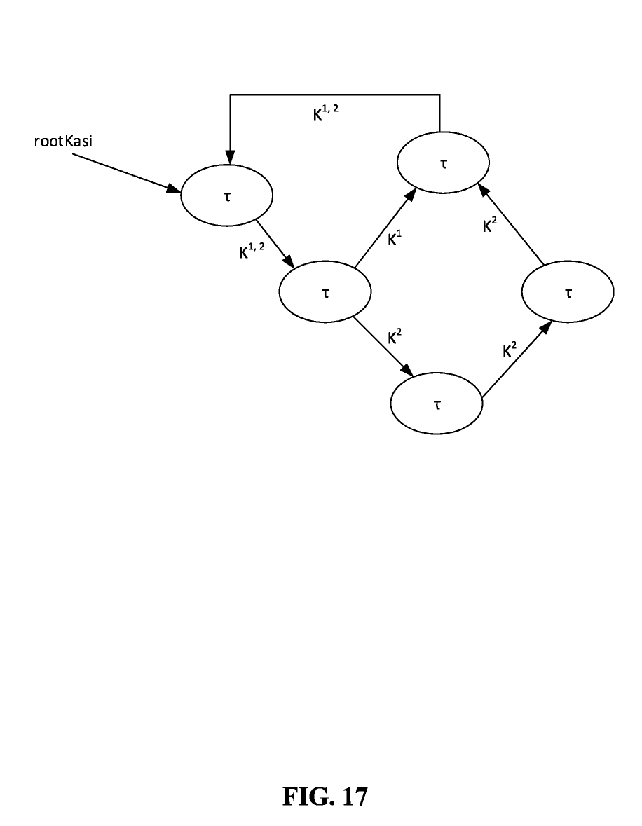

FIG. 17 is a generalized version of FIG. 14. When a new Kasi is created, the value of κ may be set to the global_c. The Kasai mainline may increment the global_c variable each time the rootKasi is traversed. Therefore, the rootKasi may need to point to the most frequently visited Kasi. Each Kasi needs a variable to count visits denoted v. If the value of v for the rootKasi is the highest v in the Sarufi, the Sarufi may be ideal. Otherwise, the Sarufi is not ideal and may need to be refactored. The refactorization may conclude with the most visited Kasi becoming the rootKasi. To the Kasai mainline, following instruction may be added prior to the end loop statement:

activeKasi->v=activeKasi->v+1; //counts visits

Refactoring may occur when the Sarufi is expanded with a new Kasi. Therefore, to the adjustSarufi( ) function, we add the following instruction within the else clause: refactorSarufi( ); The invocation of the refactorSarufi( ) function is asynchronous. Refactoring the Sarufi happens in parallel without interrupting normal processing. That is, refactoring the Sarufi may not interrupt or pause the Kasai object. If the refactorSarufi( ) function determines that the rootKasi no longer points to the most visited Kasi, the refactorSarufi( ) function may create a new Sarufi, beginning with the Kasi with the highest visit count with κ=1. Then, the Kasai algorithm may propagate forward in the old Sarufi, processing each τ by creating a new Kasi with the adjusted κ. When the new Sarufi is complete, the Kasai may switch to new Sarufi at a next anomaly.

Two fundamental differences exist between a Kasai and a neural network. There may be no hidden layers in a Kasai, and the state of all control variables and constants may be well known and traceable. The Kasai may not be a black box. Second, Kasi in the Kasai may be activated in a sequence that may mirror a pattern of the input data series. At any given time, only one Kasi may be active in a Sarufi, as a direct result of all prior inputs processed to date.

However, all processing within the Kasi may occur simultaneously and instantaneously. Each Kasi may be thought of as an independent neural network. Like the neural network, the Kasai algorithm may support pattern recognition, time series prediction, signal processing, control, aggregated sensor processing and anomaly detection. The difference may be that Kasai algorithm may operate on complex, symbolic data series, such as a series of perceptions or observations that compose behavior. Architecturally, the Kasai and the Neural Network may not be peers; the Kasai algorithm may be an abstraction that may operate on top of a neural network platform. The underlying neural network may be composed of perceptrons and may not require complex neurons.

The Kasai algorithm may detect when a neural network may need to change and detects one or more changes that may need to be made. Furthermore, the Kasai algorithm may provide the information necessary to generate a training dataset by traversing the Sarufi and generating the training dataset. Therefore, the Kasai algorithm may be used to supervise neural networks and to provide a neural network implementation with metacognitive capability.

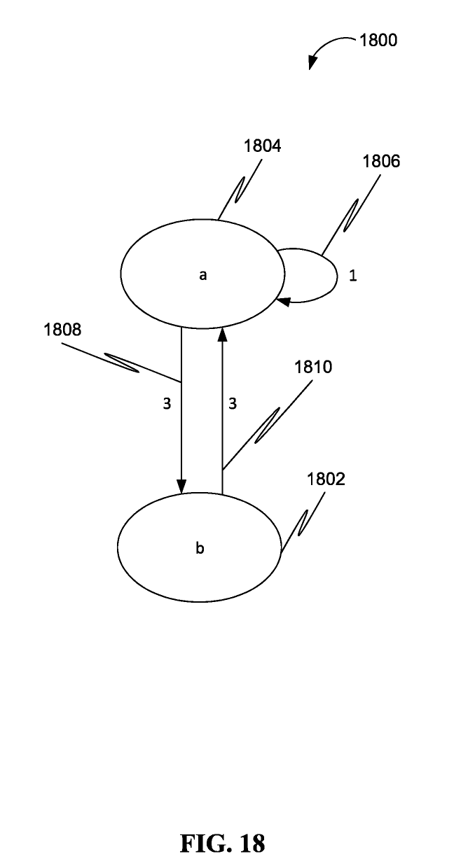

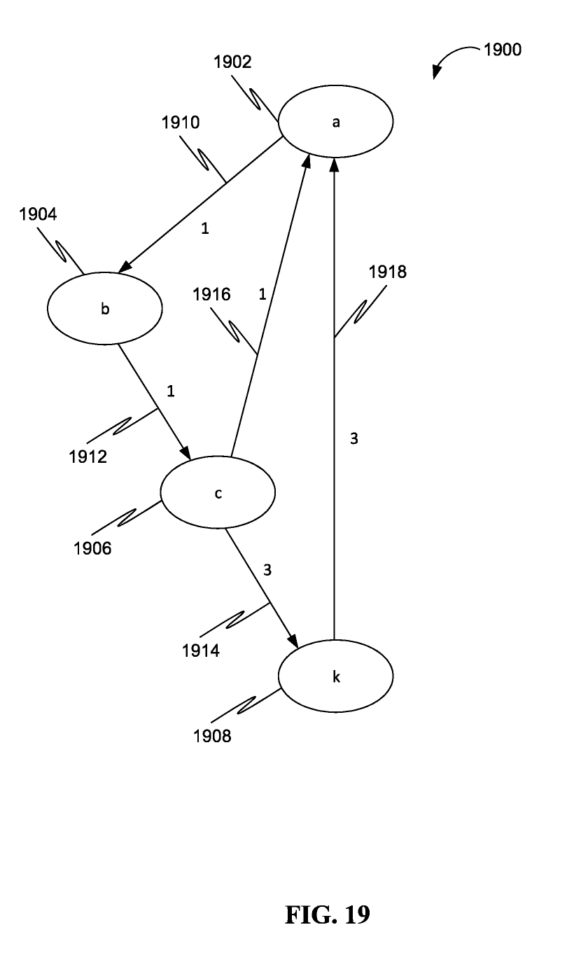

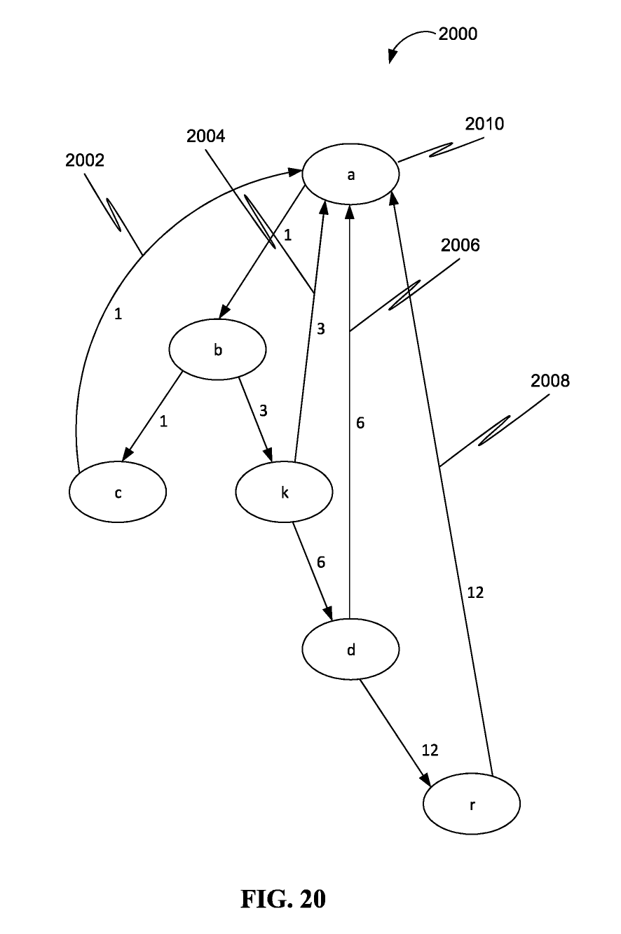

Accordingly, FIG. 18 depicts the Sarufi 1800 generated for the input sequences, in graphical form. The Sarufi 1800 may include nodes 1802-1804 connected by edges 1806-1810. FIG. 18 depicts the graphical form while the set form is: {(a→a), (aaa→b), (aaab→a)}. The number on the edge may be the number of the cycle through the root node. For example, in FIG. 18, the root is (a→a). Node (aaa→pb) may be valid after a second pass through the root node. In FIG. 20, the outermost cycle may be valid after the twelfth pass through the root node. Each cycle may require a certain charge built up by the traversal through the earlier cycles. Charge of each cycle may be independent of other charges. FIG. 19 is an illustration of a Sarufi 1900 comprising two cycles labeled with respective charge requirements (1 and 3). The Sarufi 1900 may include nodes 1902-1908 connected with edges 1910-1918. After the third traversal through the root node 1902, a charge of 3 may be built up that allows travel through the cycle. Once the root node is reached, the charge may reset.

FIG. 20 shows four cycles 2002, 2004, 2006, and 2008 with charges 1, 3, 6 and 12 respectively. Each charge may build independently and may resets when root node 2010 is reached. The sequence may contain several patterns; abc, abcabcabk, abcabcabkabcabcabkd, and abcabcab-kabcabcabkdabcabcabkabcabcabkdr, as represented by the nodes. The Sarufi 2000 may contain a cycle for each charge. The Sarufi 2000 may be a compact way to represent information contained in a very long input sequence. If the sequence contains a pattern and is not random, the Sarufi 2000 may contain cycles. Otherwise, at least one node may be a dead end. Accordingly, the knowledge about the finiteness of input sequence may be of importance. For example, a genome may be finite in the sense that the beginning and ending of the genome may be known.

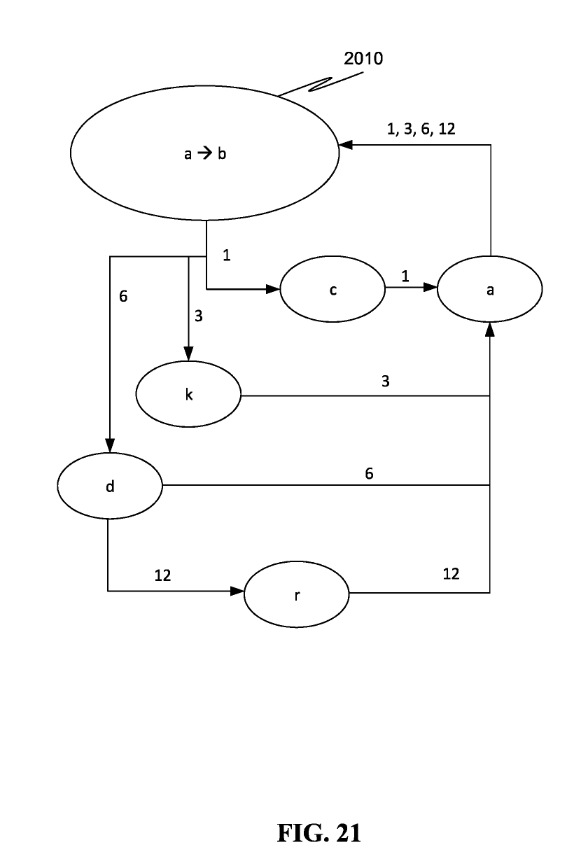

The representation of FIG. 20 may be simplified to the one shown on FIG. 21.

Further, the Kasai algorithm may consist of four distinct functions; the Kasai Mainline, the Kasi function, the adjustSarufi function and the refactorSarufi function. The time complexity of the refactor-Sarufi function may be examined separately from the other functions.

The Kasai mainline may consist of a loop iterating over a data series, one token at a time. The mainline may consist of a series of if statements. In a case where the rootKasi is active, a parallel operation may increment all Kasi charge variables. Since all the increments are done in parallel, the time complexity may be O(1). In addition, two functions signalAnomaly and signalPrediction may communicate with a client application. The two functions may be assumed to operate independently with time complexity of O(1) as well. Thus, the time complexity of the Kasai mainline may be O(1).

The Kasi may contain several instances of Θ functions. In the worst case, there may be κ instances. The Θ functions execute in parallel. Each thread compares the current charge to its own κ. If the current charge is less than or equal κ, it maps its link. After all the map operations complete, the reduce operation examines the mapped links and select the one with the highest κ. We assume an unsorted dataset because sorting the map introduces an additional performance cost. Therefore, the map operation creates an unsorted list. A parallel reduce operation on an unsorted dataset with κ elements has a time complexity of O(log κ). The worst case series consists of alternating tokens in the form [a, b, a, c, a, d, a, . . . ]. If the sequence has n elements, the Kasi with τ=[a] has n/2 κ edges. Therefore, the time complexity of the Kasi function is in the order of O(log n/2) □O(log n).

The adjustSarufi function is a simple sequence of operations. The algorithm always knows exactly where to place the new Kasi in the Sarufi and does not need to perform a search. Therefore, its time complexity is O(1).

The time complexity of the Kasai functions except refactorSarufi is O(log n). The refactorSarufi function performs the same processing except that it has a different starting point. The refactored Sarufi has the same number of Kasi but the number of edges might vary. The time complexity of the refactor-Sarufi function is also O(log n), and, it occurs independently of the other functions. Therefore, the time complexity of the Kasai algorithm may be O(log n).

Further, the Kasai algorithm may be used for singleton, network and engine applications. A singleton may be an application that may use a single Kasai object to manage on Sarufi. A network organizes a collection of Kasai objects such that the outputs of some Kasai are the inputs of another Kasai. An engine may be is a Kasai algorithm that may produce other Sarufi by direct inspection and manipulation.

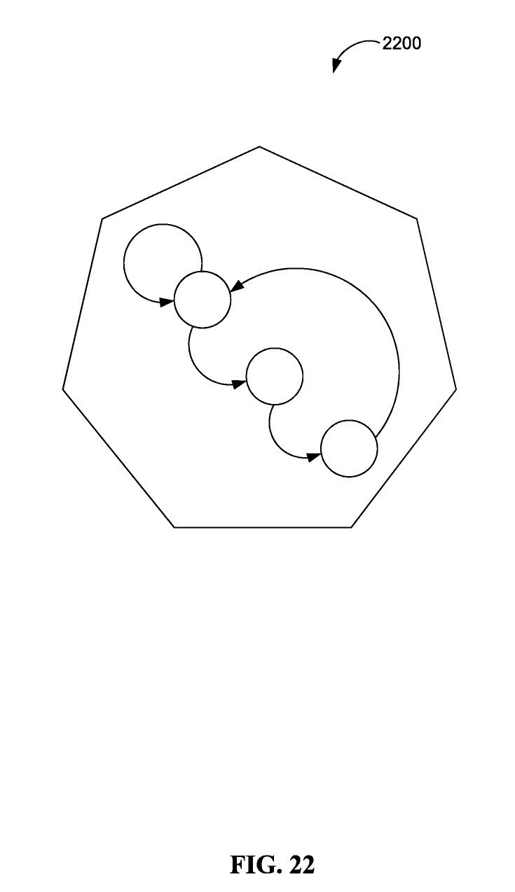

FIG. 22 is an illustration of a singleton Kasai 2200 that produces and manage a single Sarufi that represents an input sequence processed to date. There may be three Kasai implementation models: static, dynamic, and managed. The models refer to the way the Sarufi is updated. A Static Kasai algorithm may be trained and used to validate sequences. The Sarufi may not change in response to sequence. The Kasai algorithm only reports anomalies within the sequence as compared to the static Sarufi. An example may be genome analysis. The Kasai algorithm may be trained using a reference human genome. Then other genomes or aberrant genomes may be compared to classify or to find differences.

A Dynamic Kasai may immediately change the Sarufi to reflect patterns in the sequence. An example is smart cars. A smart car may need to adjust expectations based on changing conditions in the environment and on the road.

A Managed Kasai is may be a dynamic Kasai algorithm under control of a client application. The Kasai may operate in static mode until the client application instructs to operate in a dynamic mode. The Kasai algorithm may be a part of the General Purpose Metacognition Engine (GPME) (M'Balé & Josyula, 2016, 2014a, 2014b). The GPME is an AI agent that enhances the performance of intelligent systems. The GPME may accept a time-series of observations from sensors. Sensory input may be noisy. Therefore, the GPME may create episodes of observations and may cluster similar episodes and generate a cluster centroid episode called a Case. The cases may be inputs into the Kasai algorithm. The Kasai algorithm may supply predictions of the future state of the environment. The GPME may analyze the anomalies to determine when the Sarufi may need to be modified. A client application may apply the Kasai algorithm in several broad ways; classification, prediction, memory, and training.

Classification may allow analysis of a sequence using a Sarufi to determine if the sequence belongs to the same class as the original sequence. A related classification is to produce the Sarufi for various sequences and compare their Sarufi. For instance, intrusion detection systems may rely on rules to detect normal behavior. Intrusion detection systems may use statistical analysis to develop typical profiles of behavior for one or more customers. Using the Kasai algorithm, each intrusion detection implementation may develop a unique own set of rules that may accurately reflect normal and abnormal behavior.

Prediction may allow determination of a next valid state given all prior states. The sequence may be a time-series and the Kasai algorithm may predict the future state of the time-series. For instance, in a for stock market prediction, a token may be designed consisting of economic and demographic indicators, and price of a commodity. Some data preparation may be necessary to eliminate noise. For example, actual values at market close may not be used, instead a symbol that may denote a trend or direction (Up, Down, No change, etc.) may be used. The indicators may be supplied and a predicted value trend may be received. The Kasai algorithm may not be used to predict the actual price of a share. In general, if input domain is broad, some preprocessing of the input may create a level of abstraction that may simplify the Sarufi without losing fidelity.

Memory may allow reproduction of an original input sequence. The Kasai algorithm may be to compress a large non-random data sequence into a more portable form. A practical example is genome data compression. Genome data sets may contain millions of genes in an order the genes are found in a cell. A Kasai algorithm trained on genome may eliminate redundant sequences in the genome while maintaining the fidelity of the gene sequences.

Training may allow creation of dynamic objects that may not be naturally dynamic. The Kasai algorithm may be used to train other objects. For example, Rete algorithm is a pattern matching algorithm for implementing production rule systems. An implementation of a rules engine may fire a rule when its database indicates that the conditions are met. It may be necessary for a human designer to specify rules to the rules engine. The Kasai algorithm may be used to identify rules that should be implemented in the rules engine.

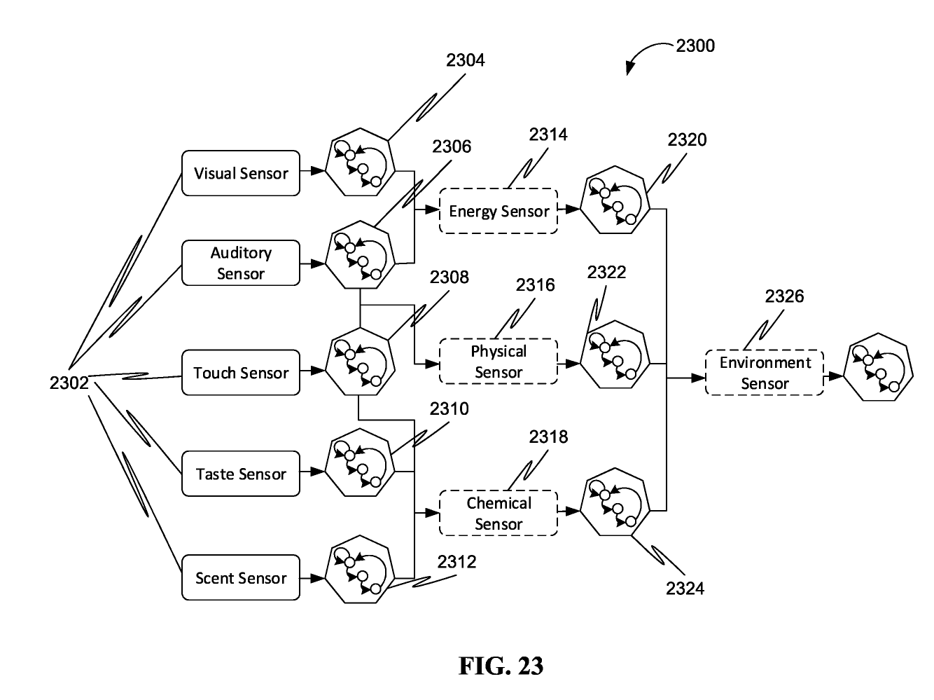

Further, a Kasai Network may be an arrangement of Kasai algorithm such that the output of one Kasai may be input of another. FIG. 23 is an illustration of an exemplary Kasai Network 2300. The construction of a unified environment Kasai network may be created from a combination of instances of other Kasai algorithms. On the left, five physical sensors 2302 may produce sequences that may be input into assigned Kasai algorithms 2304, 2306, 2308, 2310, and 2312 respectively. The outputs of these Kasai algorithms 2304, 2306, 2308, 2310, and 2312 may be combined to form virtual sensors 2314, 2316, and 2318 such as a virtual energy sensor 2314, virtual physical sensor 2316, and virtual chemical sensor 2318. In turn, the combined output from the energy, physical and chemical Kasai algorithms, 2320, 2322, and 2324, respectively, may form a virtual environment sensor 2326, which may enable prediction of the state of the environment. This example is like the application of the Kasai in the GPME.

The GPME is a design to enable behavior-oriented intelligence. Behavior composition, as we described earlier, requires a trigger different from the stimulus that generates the response. To initiate behavior composition, we must know that a stimulus outside of the norm has occurred. Therefore, the GPME uses a Kasai network to construct a representation of the environment that captures what is normal in its experience. Any stimulus that is not predicted by this network is an anomaly that triggers behavior composition.

Since the sensor array provides a large amount of data within which the patterns can be found. The GPME breaks the data series into sequences called episodes using an anomaly detection mechanism. The GPME clusters episodes with the same anomaly signature to generate a centroid. The centroid is the intersection of the cluster members. GPME clusters have a fixed size. They discard members in favor of new members that reduce the hamming distance between the centroid and the cluster members. In the GPME, the Kasai Network processed series of centroids.

A Kasai Engine may use a Kasai singleton or network to produce a baseline set of Sarufi and manipulates the Sarufi to produce new Sarufi. The new Sarufi may be the result of operations on the set of paths defined in the Sarufi. For example, if a patient population has a genetic medical condition, and a population of individuals without the genetic medical condition, the determination of one or more genes that may contribute to the genetic medical condition may be performed using a Kasai Engine.

Each patient genome may be assigned to a Kasai algorithm resulting in a Sarufi for each genome. An intersection operation may be on all of the Sarufi, and the resulting Sarufi (S^{c}) may contain the genome sequence rules for the condition as well as rules that may represent gene sequences the population shares. The same exercise may be performed on the individuals without the conditions and Sarufi S^{p} may be produced representing healthy individuals. The complement of S^{p} and S^{c} may be taken and a Sarufi S^{d}=(S^{c}−S^{P}) may be produced that may contain the genome sequence rules for the genes that contribute to the genetic medical condition.

Further, Sarufi calculus may include all set operations since a Sarufi is a set of paths. The functions may include intersection, union, subset (superset), proper subset (proper superset), not subset, power set, equality, complement (relative not absolute), difference, membership, cardinality, and empty set.

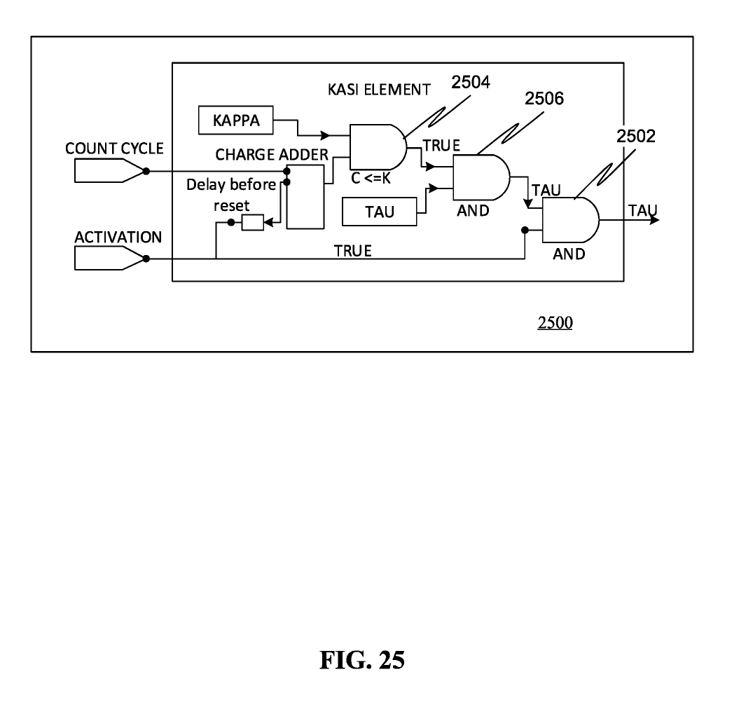

In some embodiments, the Kasai may be implemented in hardware, on-chip. FIG. 25 is an illustration of a conceptual hardware Kasi element 2500. Each Kasi circuit may consist of memory storage for the parameters (κ and τ) and the charge, and may require an addition circuit to increment the charge. The output may be τ. Once initialized with parameters, the Kasi element may increment the charge when count cycle signal is received. When the Kasi receives the activation signal, resetting of the charge adder is delayed so that the Kasi circuit may operate one last time. The activation may enable the final (rightmost) output AND gate 2502. On the left, the first logic gate 2504 may compare the charge to κ. If the output is TRUE, the gate 2504 may enable the AND gate 2506 that may present τ to the final gate 2502. Thus, τ is the output upon activation.

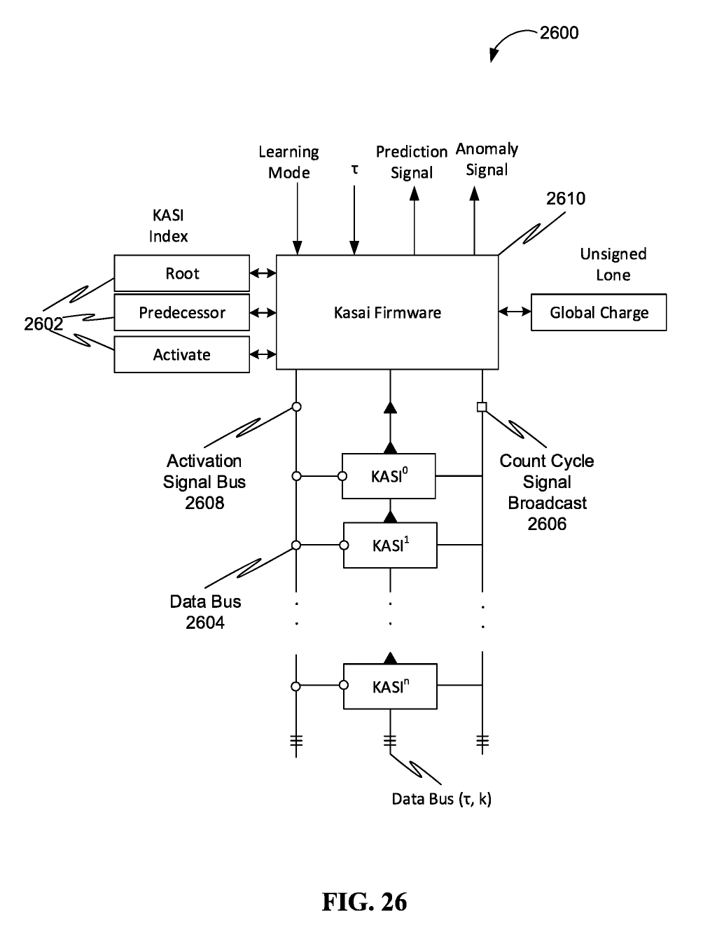

A Kasai chip 2600 may be built using several Kasi elements as shown in FIG. 26. The Kasai chip 2600 consists of a bank of Kasi elements 2602 connected to the firmware processor 2610 via three connections. The data bus, 2604 may address each Kasi by an index. The data bus 2604 may address the τ and κ when the Kasi may be initialized and receives the τ and κ when the Kasi fires. The activation bus 2608 may address each Kasi individually to signal the Kasi to fire. Only one Kasi may receive the activation signal at a time. On the right, the count cycle signal broadcast 2606 may instruct each Kasi to increment charge. The Kasai chip 2600 may accept a setting for the learning mode and an input τ and produces prediction and anomaly signals. Each Kasai chip 2600 may operate a single Kasai. A Kasai network may require several Kasai chips to interconnect.

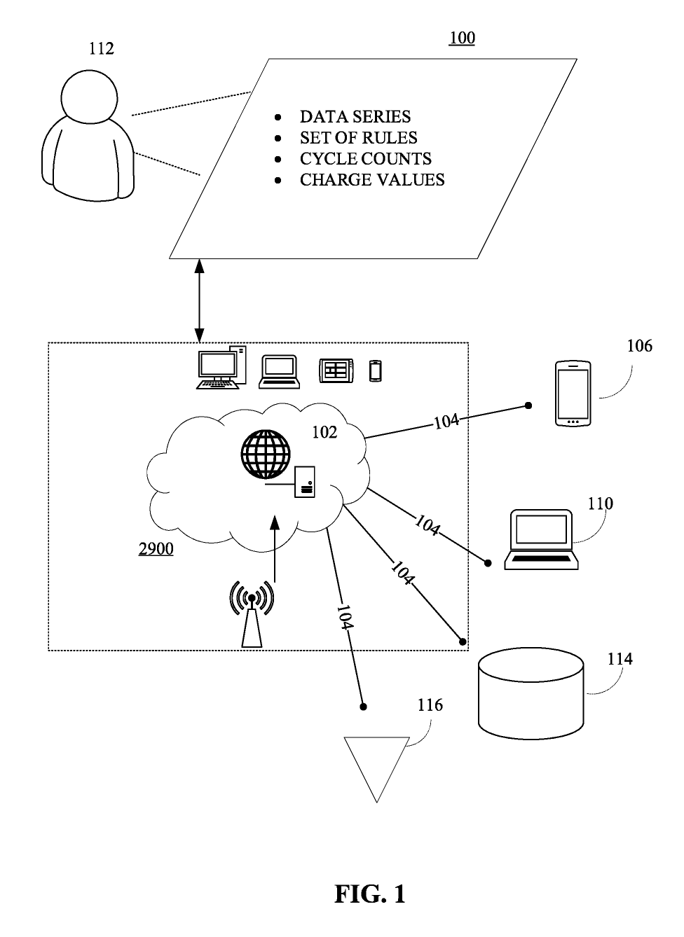

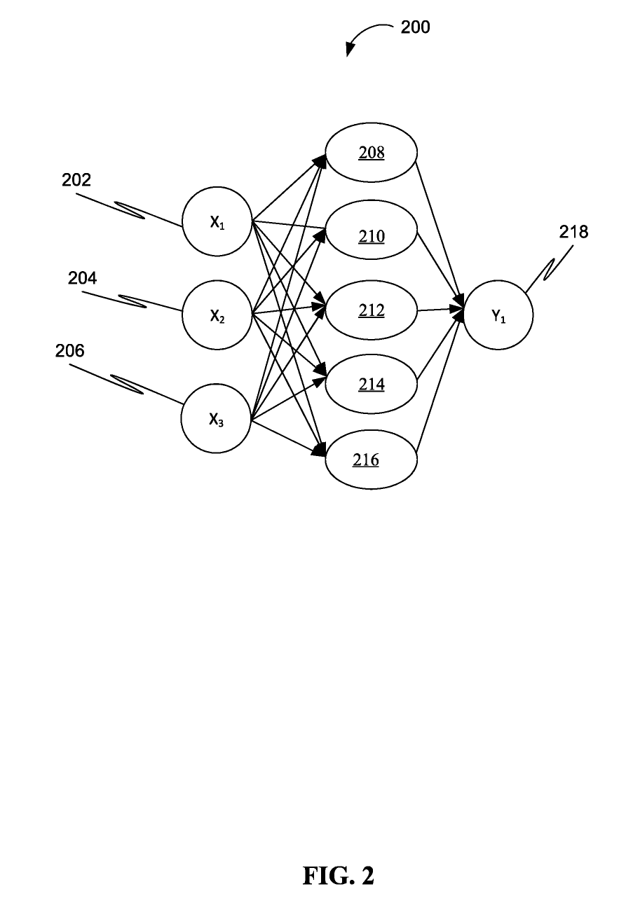

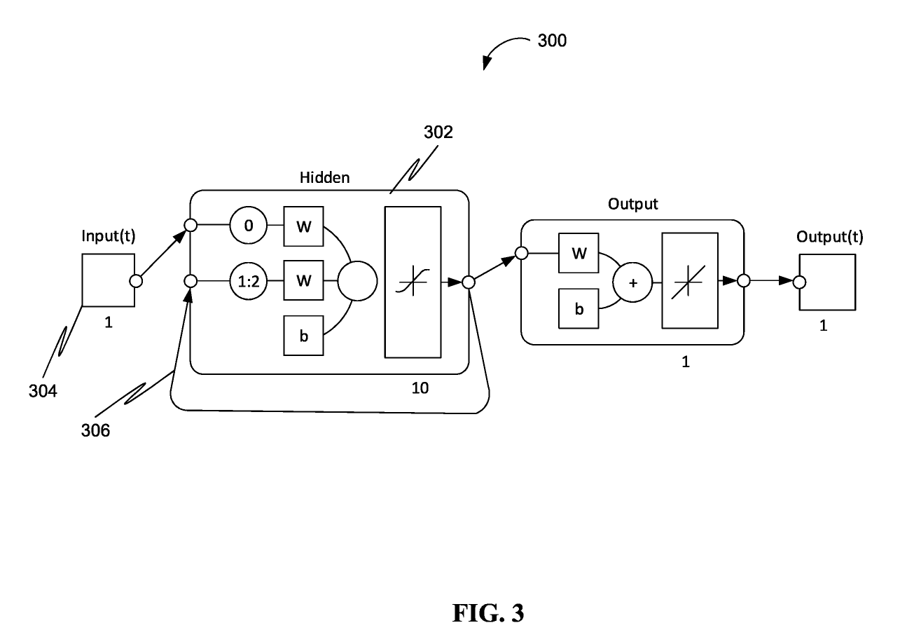

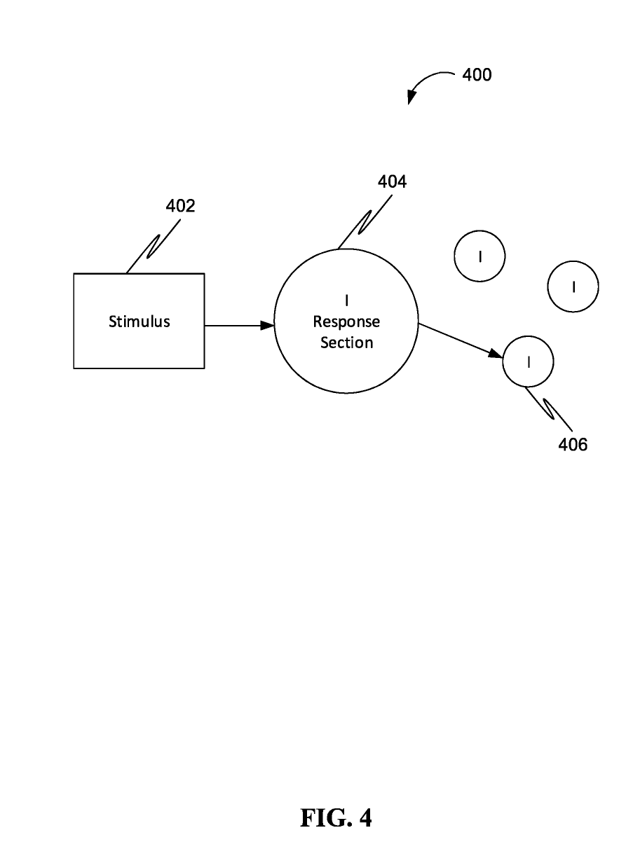

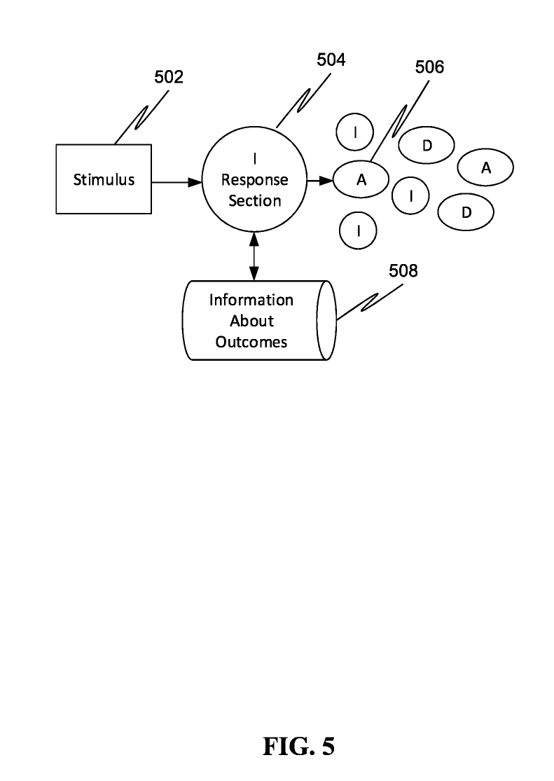

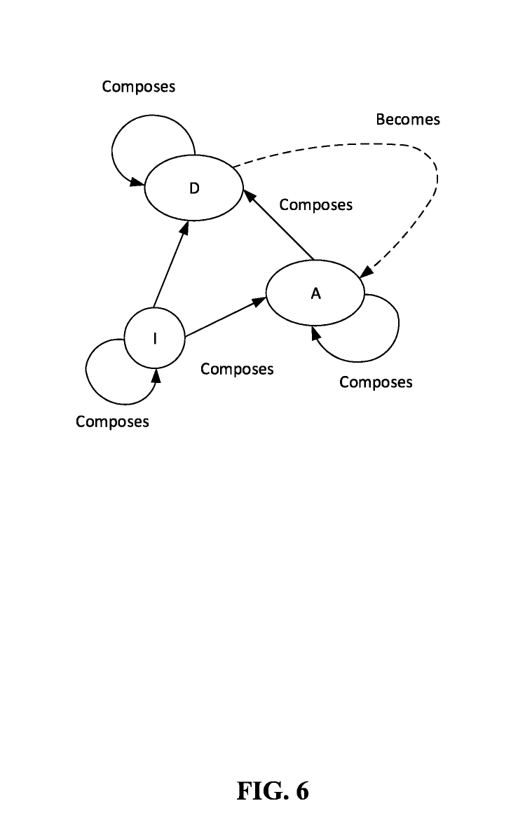

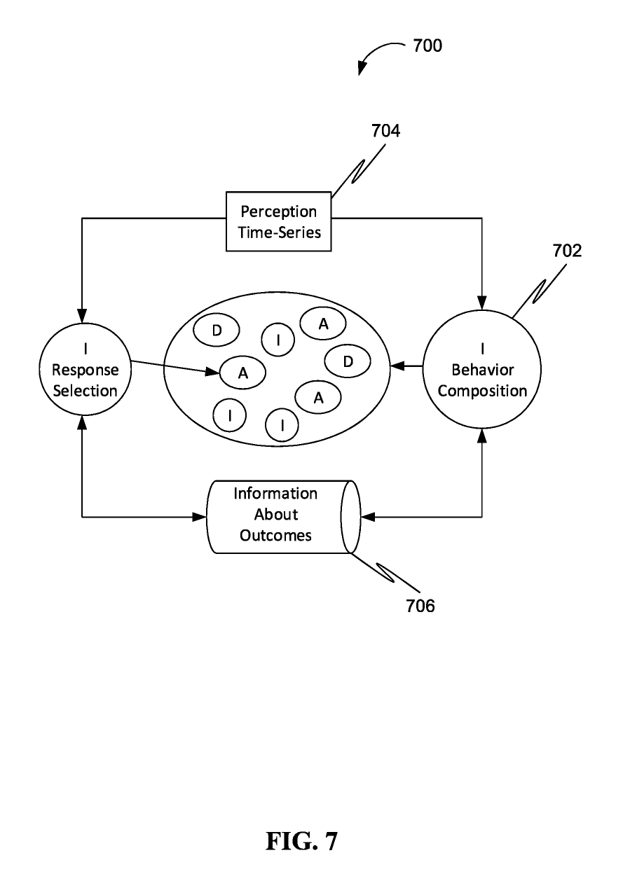

FIG. 1 is an illustration of a platform consistent with various embodiments of the present disclosure. By way of non-limiting example, the online platform 100 facilitation of analysis of a data series to create a set of rules may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114 (e.g. other online platforms providing one or more data series, such as weather databases), and sensors 116 (such as one or more sensors providing one or more data points relating to one or more data series, such as temperature sensors) over a communication network 104, such as, but not limited to, the Internet. Further, users of the platform may include relevant parties such as one or more of researchers, academicians, data miners, etc. Accordingly, electronic devices operated by the one or more relevant parties may be in communication with the platform. For example, the mobile device 106 may be operated by a researcher, who may provide a data series for analysis, and receive a set of rules defining the data series.

A user 112, such as the one or more relevant parties, may access platform 100 through a web-based software application or browser. The web-based software application may be embodied as, for example, but not be limited to, a website, a web application, a desktop application, and a mobile application compatible with a computing device 2900.

According to some embodiments, the online platform 100 may communicate with a system 2700 to facilitate analysis of a data series to create a set of rules.

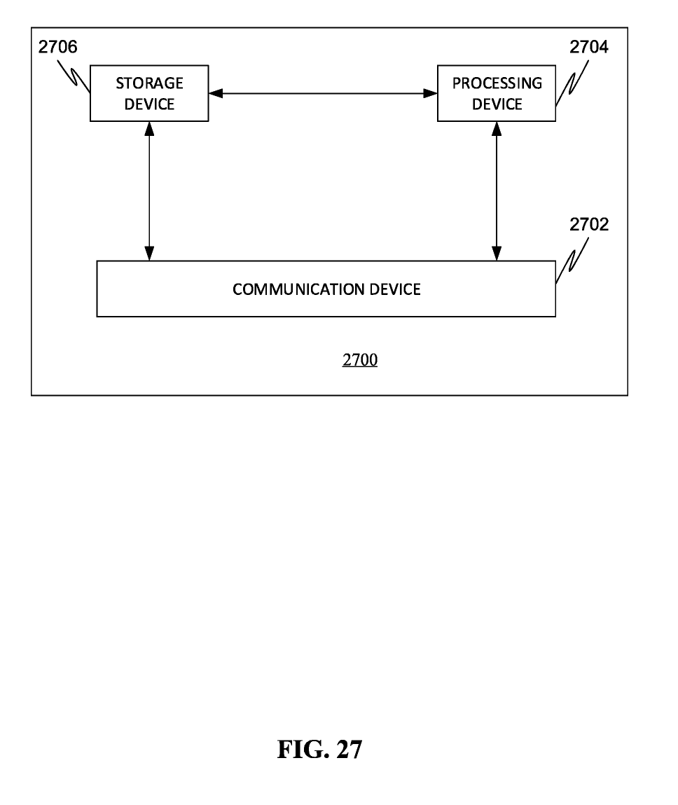

FIG. 27 is a block diagram of the system 2700 for facilitating analysis of a data series to create a set of rules. In some embodiments, the system may be implemented as a hardware chip, such as a Kasai chip 2600. The system 2700 may include a communication device configured to receive a data series, wherein the data series may be processed before the data series is received at the communication device 2702.

The system may not perform any noise detection, and may assume that the data series received the system may not include noise. The data series may include a sequence of tokens, wherein a token in the sequence of tokens may be a raw datum. Further, the data series may include one or more patterns, wherein a pattern in the one or more patterns may include one of a reflexive pattern (such as the reflexive directed graph 800), a periodic pattern (such as the periodic directed graph 900), a cyclical pattern, a hybrid pattern (such as the hybrid directed graph 1200) or a seasonal pattern. Further, the system 2700 may include a processing device configured to analyze the data series. Analyzing the data series may include identifying one or more patterns in the data series. Further, the system 2700 may dynamically generate one or more rules based on the analyzing, wherein the one or more rules may form a grammar. Further, the generating the one or more rules may include creating, device, a rule for each detected pattern. Further, a rule in the one or more rules may include an indication of a symbol predicting a token, wherein the symbol may be a sequence of tokens. In an embodiment, the set of one or more rules may be called as Sarufi.

Further, the grammar may be represented as a directed graph comprising one or more nodes and one or more edges, wherein the one or more nodes may represent the one or more rules, and the one or more edges may form a unique path through the one or more nodes. Further, the directed graph may be fully connected and all nodes in the one or more nodes may be reachable. Further, the processing device 2704 may assign one or more cycle values for one or more cycles in the directed graph to obtain an enhanced directed graph. A cycle in the one or more cycles may be a path that may lead back to a root node. Further, one or more charge values may be assigned to the one or more cycles. The one or more charge values may be built through cycle traversal, and may describe temporal constraints inherent within the input sequence. For instance, timing may be a part of a description of the rules generated by the system 2700.

Further, the grammar may represent the static structure of the data series using the one or more rules and one or more paths, wherein a path in the one or more paths may be a sequence of edges that may leads back to a root node. Further, the enhanced directed graph may capture both the static and dynamic structures of the data series. Further, in an embodiment, the processing device 2704 may be configured to traverse the enhanced directed graph to regenerate the data series, wherein traversing the enhanced graph may start from the root node. The initial charge value of each cycle in the one or more cycles is set to zero, and the one or more charge values may be incremented by one each time the root node is reached during the traversing. Further, when a charge value in the one or more charge values reaches the corresponding cycle value, the respective cycle may be traversed and once a cycle in the one or more cycles is traversed, the corresponding charge value is set back to zero. Further, the system 2700 may include a storage device 2706 configured to store the one or more rules, the one or more cycle values and the one or more charge values.

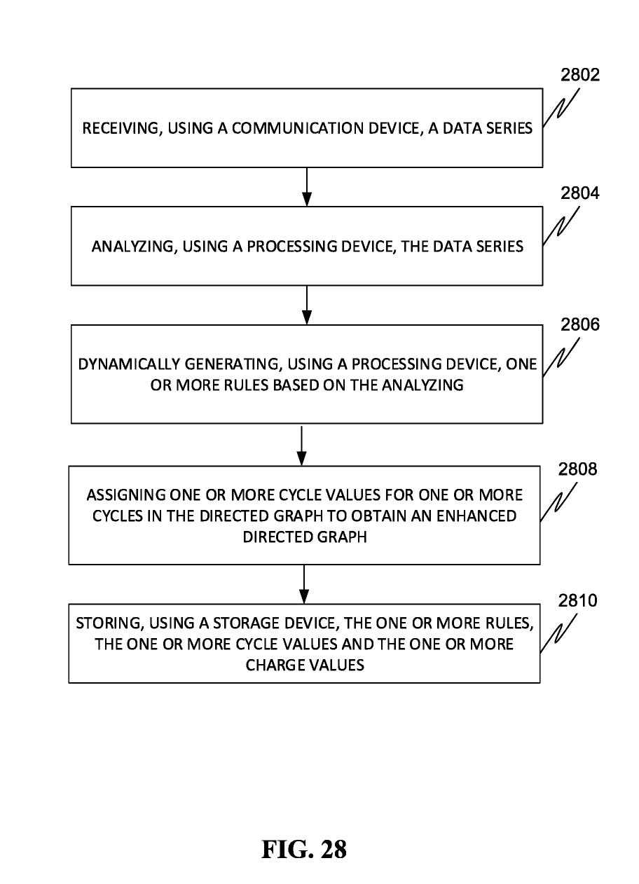

FIG. 28 is a flowchart of a method 2800 of facilitating analysis of a data series to create a set of rules, in accordance with some embodiments. According to some embodiments, the online platform 100 may execute the method 2800.

At 2802, the method may include receiving, using a communication device (such as the communication device 2702), a data series wherein the data series may be processed before the data series is received at the communication device. Further, the data series may include a sequence of tokens, wherein a token in the sequence of tokens may be raw datum. Further, the data series may include one or more patterns, wherein a pattern in the one or more patterns may be one of a reflexive pattern, a periodic pattern, a cyclical pattern, a hybrid pattern or a seasonal pattern.

At 2804, the method may include analyzing, using a processing device (such as the processing device 2704), the data series. Analyzing the data series may include identifying one or more patterns in the data series.

At 2806, the method may include dynamically generating, using the processing device (such as the processing device 2704), one or more rules based on the analyzing, wherein the generating the one or more rules may include creating, using the processing device, a rule for each detected pattern, in accordance with some embodiments. Further, a rule in the one or more rules may include an indication of a symbol predicting a token, wherein the symbol may be a sequence of tokens. Further, the one or more rules may form a grammar. Further, the grammar may be represented as a directed graph comprising one or more nodes and one or more edges, wherein the one or more nodes may represent the one or more rules. Further, the one or more edges may form a unique path through the one or more nodes. Further, the directed graph may be fully connected and all nodes in the one or more nodes may be reachable.

At 2808, the method may include assigning one or more cycle values for one or more cycles in the directed graph to obtain an enhanced directed graph, wherein a cycle in the one or more cycles may be a path that may lead back to a root node. Further, one or more charge values may be assigned to the one or more cycles. The one or more charge values may be built through cycle traversal and may describe one or more temporal constraints inherent within the input sequence. Further, the grammar may represent the static structure of the data series using the one or more rules and one or more paths, wherein a path in the one or more paths may be a sequence of edges that may lead back to a root node. Further, the enhanced directed graph may capture both the static and dynamic structures of the data series. Further, in an embodiment, the enhanced directed graph may be traversed to regenerate the data series, wherein traversing the enhanced graph may start from the root node. The initial charge value of each cycle in the one or more cycles may be set to zero, and the one or more charge values may be incremented by one each time the root node is reached during the traversing. Further, when a charge value in the one or more charge values reaches the corresponding cycle value, the respective cycle may be traversed and once a cycle in the one or more cycles is traversed, the corresponding charge value may be set back to zero.

At 2810, the method may include storing, using a storage device (such as the storage device 2706), the one or more rules, the one or more cycle values and the one or more charge values.

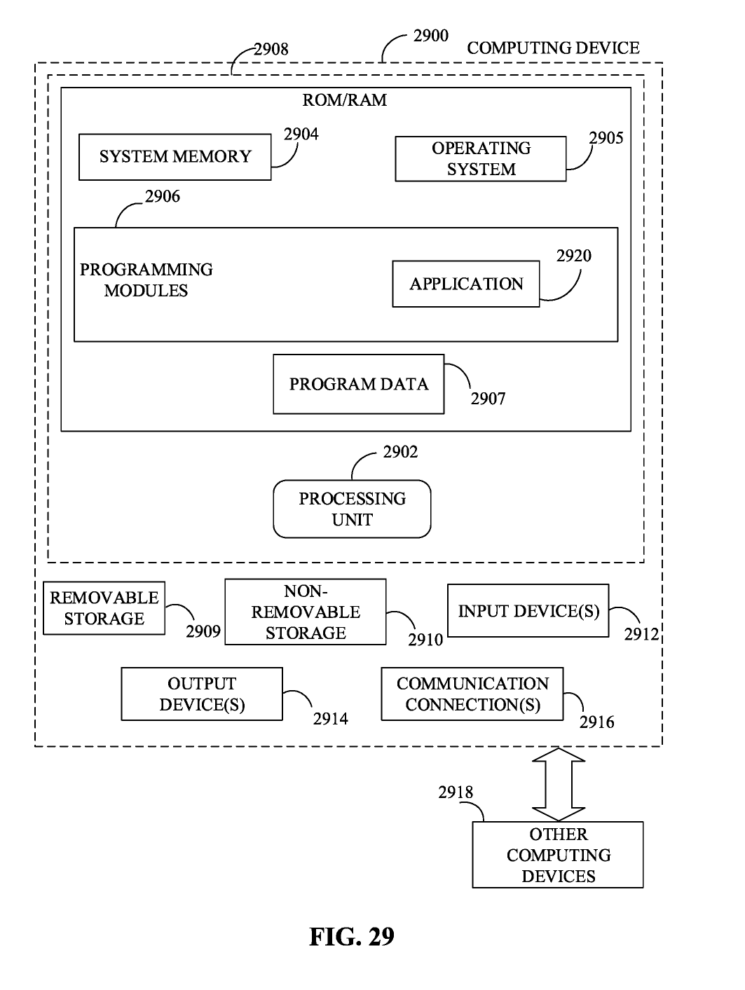

FIG. 29 is a block diagram of a computing device for implementing the methods disclosed herein, in accordance with some embodiments. Consistent with an embodiment of the disclosure, the aforementioned storage device and processing device may be implemented in a computing device, such as computing device 2900 of FIG. 29. Any suitable combination of hardware, software, or firmware may be used to implement the memory storage and processing unit. For example, the storage device and the processing device may be implemented with computing device 2900 or any of other computing devices 2918, in combination with computing device 2900. The aforementioned system, device, and processors are examples and other systems, devices, and processors may comprise the aforementioned storage device and processing device, consistent with embodiments of the disclosure.

With reference to FIG. 29, a system consistent with an embodiment of the disclosure may include a computing device or cloud service, such as computing device 2900. In a basic configuration, computing device 2900 may include at least one processing unit 2902 and a system memory 2904. Depending on the configuration and type of computing device, system memory 2904 may comprise, but is not limited to, volatile (e.g. random access memory (RAM)), non-volatile (e.g. read-only memory (ROM)), flash memory, or any combination. System memory 2904 may include operating system 2905, one or more programming modules 2906, and may include a program data 2907. Operating system 2905, for example, may be suitable for controlling computing device 2900's operation. Furthermore, embodiments of the disclosure may be practiced in conjunction with a graphics library, other operating systems, or any other application program and is not limited to any particular application or system. This basic configuration is illustrated in FIG. 29 by those components within a dashed line 2908.

Computing device 2900 may have additional features or functionality. For example, computing device 2900 may also include additional data storage devices (removable and/or non-removable) such as, for example, magnetic disks, optical disks, or tape. Such additional storage is illustrated in FIG. 29 by a removable storage 2909 and a non-removable storage 2910. Computer storage media may include volatile and nonvolatile, removable and non-removable media implemented in any method or technology for storage of information, such as computer-readable instructions, data structures, program modules, or other data. System memory 2904, removable storage 2909, and non-removable storage 2910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2900. Any such computer storage media may be part of device 2900. Computing device 2900 may also have input device(s) 2912 such as a keyboard, a mouse, a pen, a sound input device, a touch input device, etc. Output device(s) 2914 such as a display, speakers, a printer, etc. may also be included. The aforementioned devices are examples and others may be used.

Computing device 2900 may also contain a communication connection 2916 that may allow device 2900 to communicate with other computing devices 2918, such as over a network in a distributed computing environment, for example, an intranet or the Internet. Communication connection 2916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2904, including operating system 2905. While executing on processing unit 2902, programming modules 2906 (e.g., application 2920) may perform processes including, for example, one or more stages of method 2800, algorithms, systems, applications, servers, databases as described above. The aforementioned process is an example, and processing unit 2902 may perform other processes. Other programming modules that may be used in accordance with embodiments of the present disclosure may include sound encoding/decoding applications, machine learning application, acoustic classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

What is claimed is:

1. A method of analysing a data series, the method comprising:
receiving, using a communication device, a data series;
analyzing, using a processing device, the data series;
dynamically generating, using a processing device, one or more rules based on the analyzing, wherein the one or more rules form a grammar, wherein the grammar is represented as a directed graph comprising one or more nodes and one or more edges, wherein the one or more nodes representing the one or more rules, wherein the one or more edges forming a unique path through the one or more nodes;
assigning one or more cycle values for one or more cycles in the directed graph to obtain an enhanced directed graph, wherein a cycle in the one or more cycles is a path that leads back to a root node, wherein one or more charge values are assigned to the one or more cycles; and
storing, using a storage device, the one or more rules, the one or more cycle values and the one or more charge values.

2. The method of claim 1, wherein the data series is processed before the data series is received at the communication device.

3. The method of claim 1, wherein the data series includes a sequence of tokens, wherein a token in the sequence of tokens is a raw datum.

4. The method of claim 1, wherein the data series includes one or more patterns, wherein a pattern in the one or more patterns is one of a reflexive pattern, a periodic pattern, a cyclical pattern, a hybrid pattern and a seasonal pattern.

5. The method of claim 4, wherein the analyzing the data series includes identifying, using a processing device, one or more patterns in the data series.

6. The method of claim 4, wherein the generating the one or more rules includes creating, using the processing device, a rule for each detected pattern.

7. The method of claim 1, wherein a rule in the one or more rules may include an indication of a symbol predicting a token, wherein the symbol is sequence of tokens.

8. The method of claim 1, wherein the graph is fully connected and all nodes in the one or more nodes are reachable.

9. The method of claim 1, wherein the grammar represents the static structure of the data series using the one or more rules and one or more paths, wherein a path in the one or more paths is a sequence of edges that leads back to a root node, wherein the enhanced directed graph captures both the static and dynamic structures of the data series.

10. The method of claim 1 further includes traversing the enhanced graph to regenerate the data series, wherein the traversing starts from the root node, wherein an initial charge value of each cycle in the one or more cycles is set to zero, wherein the one or more charge values are incremented by one each time the root node is reached during the traversing, wherein when a charge value in the one or more charge values reaches the corresponding cycle value, the respective cycle is traversed, wherein once a cycle in the one or more cycles is traversed, the corresponding charge value is set back to zero.

11. A system of analysing a data series, the system comprising:
a communication device configured to receive a data series;
a processing device configured to:
analyze the data series;
dynamically generate one or more rules based on the analyzing, wherein the one or more rules form a grammar, wherein the grammar is represented as a directed graph comprising one or more nodes and one or more edges, wherein the one or more nodes representing the one or more rules, wherein the one or more edges forming a unique path through the one or more nodes;
assign one or more cycle values for one or more cycles in the directed graph to obtain an enhanced directed graph, wherein a cycle in the one or more cycles is a path that leads back to a root node, wherein one or more charge values are assigned to the one or more cycles; and
a storage device configured to store the one or more rules, the one or more cycle values and the one or more charge values.

12. The system of claim 11, wherein the data series is processed before the data series is received at the communication device.

13. The system of claim 11, wherein the data series includes a sequence of tokens, wherein a token in the sequence of tokens is a raw datum.

14. The system of claim 11, wherein the data series includes one or more patterns, wherein a pattern in the one or more patterns is one of a reflexive pattern, a periodic pattern, a cyclical pattern, a hybrid pattern and a seasonal pattern.

15. The system of claim 14, wherein the analyzing the data series includes identifying, using the processing device, one or more patterns in the data series.

16. The system of claim 14, wherein the generating the one or more rules includes creating, using the processing device, a rule for each detected pattern.

17. The system of claim 11, wherein a rule in the one or more rules may include an indication of a symbol predicting a token, wherein the symbol is sequence of tokens.

18. The system of claim 11, wherein the graph is fully connected and all nodes in the one or more nodes are reachable.

19. The system of claim 11, wherein the grammar represents the static structure of the data series using the one or more rules and one or more paths, wherein a path in the one or more paths is a sequence of edges that leads back to a root node, wherein the enhanced directed graph captures both the static and dynamic structures of the data series.

20. The system of claim 11, wherein the processing device is further configured to traverse the enhanced graph to regenerate the data series, wherein traversing the enhanced graph starts from the root node, wherein an initial charge value of each cycle in the one or more cycles is set to zero, wherein the one or more charge values are incremented by one each time the root node is reached during the traversing, wherein when a charge value in the one or more charge values reaches the corresponding cycle value, the respective cycle is traversed, wherein once a cycle in the one or more cycles is traversed, the corresponding charge value is set back to zero.
